(19) United States
(12) Patent Application Publication
(10) Pub. No.: US 2006/0249554 A1
(43) Pub. Date: Nov. 9, 2006

(54) PNEUMATIC NAILER

(75) Inventors: Robert W. Butzen, Colgate, WI (US); Gary D. Meyer, Waukesha, WI (US); Richard H. Jungmann, Richfield, WI (US); Melissa Ottens-Rendon, Waukesha, WI (US); Roger D. Neitzell, North Prairie, WI (US)

Correspondence Address: MICHAEL, BEST & FREIDRICH LLP, 100 EAST WISCONSIN AVENUE, SUITE 3300, MILWAUKEE, WI, 53202, US

(73) Assignee: MILWAUKEE ELECTRIC TOOL CORPORATION, Brookfield, WI (US)

(21) Appl. No.: 11/458,430

(22) Filed: Jul. 19, 2006

Related U.S. Application Data
(63) Continuation of application No. 10/858,434, filed on Jun. 1, 2004.
(60) Provisional application No. 60/474,710, filed on May 29, 2003.

(51) Int. Cl. B25C 1/04

(52) U.S. Cl. 227/130; 227/8

(57) ABSTRACT

Power tools, nailers and strips of fasteners. In some aspects and in some constructions, the invention may provide a power tool including a housing, a deflector selectively movable relative to the housing between a first position, in which the deflector deflects fluid in a first direction, and a second position, in which the deflector deflects fluid in a second direction. In some aspects and in some constructions, the invention may provide a nailer including a magazine operable to support a strip of fasteners in an orientation therein, the magazine defining an insertion opening therein through which the strip of fasteners is insertable into the magazine, the insertion opening having a configuration, the strip of fasteners having a configuration complementary to the configuration of the insertion opening, the strip of fasteners insertable into the magazine only when the strip of fasteners is in the orientation.

### RELATED APPLICATIONS

The present application is a continuation of prior filed, co-pending U.S. patent application Ser. No. 10/858,434, filed Jun. 1, 2004, which claims the benefit of U.S. Provisional Patent Application Ser. No. 60/474,710, filed May 29, 2003, the contents of all are hereby incorporated by reference.

### FIELD OF THE INVENTION

The present invention relates to power tools and, more particularly, to pneumatic nailers.

### SUMMARY OF THE INVENTION

Conventional nailers, such as pneumatic nailers and combustion nailers, are operable to drive fasteners into workpieces. Such nailers typically include a housing for supporting a drive assembly, a handle, a trigger assembly connectable to the drive assembly to cause firing of the drive assembly, a magazine for supporting fasteners therein and a power source, such as a pneumatic source or a combustion device, operable to power the drive assembly and drive fasteners into a workpiece.

In the workplace, nailers may often be subject to unwanted forces caused by, for example dropping the nailer, stepping on the nailer, or otherwise impacting the nailer/components of the nailer. All of these unwanted forces can damage the housing of the nailer and/or the internal components of the nailer. Damaging the housing decreases the aesthetic appealability of the nailer and can cause the nailer to operate incorrectly or to not operate at all.

Some nailers, such as pneumatic nailers, are powered with air and exhaust air therefrom after each operation cycle. Exhausted air may exhaust in an undefined or less-than-preferred direction from the nailer (e.g., may exhaust at the operator (into the operator's face, at the operator's body)) and may cause discomfort to the operator or affect the operation of the nailer. Exhausted air can also blow particles, such as, for example dust, dirt, saw dust, debris, etc., in unwanted directions around the work area, such as, for example at the operator (into the operator's face), onto the workpiece, or randomly into the air, to cause discomfort to an operator, to affect operation of the nailer or to simply make a mess of the work area.

Fasteners may be incorrectly loaded into some conventional nailers. Fasteners are typically arranged together using collation material, which may be made of plastic and which may arranged in one or two rows along the bundle of fasteners. Nailers typically have magazines into which fasteners may be incorrectly inserted by an unwary or inattentive operator. If the bundle, stick or set of collated fasteners is inserted incorrectly, the leading fastener may not be properly aligned with the drive assembly and can be driven in the incorrect orientation or in an incorrect direction. Driving the leading fastener in the improper orientation/direction may damage the nailer, such as, for example, damaging the drive assembly, driving the nail through a wall of the magazine or other portion of the nailer, may damage the workpiece or surrounding equipment or may cause an injury to an operator. Conventional nailers typically do not prevent the conventional nailer from firing when the collated fasteners are inserted incorrectly.

Some conventional nailers also include magazines that support the bundles of fasteners therein by engaging the fasteners. Typically, the heads or other portions of the fasteners engage interior surfaces of the magazine and slide therealong. Fasteners are commonly made of metal and can wear the interior surfaces of the magazine, which are typically made of plastic, after repeated use thereof. Such wear can cause the magazine to misguide the fasteners and improperly align the fasteners with the drive assembly or fasteners can jam within the magazine.

Conventional nailers are often utilized in spaces having limited room for movement. Loading fasteners into the magazine in such cramped spaces can be a difficult if not impossible task. Magazines of some conventional nailers typically include a support portion secured to the housing of the nailer and a cover slidable along the support portion to expose the interior of the magazine and allow fasteners to be inserted into the magazine. In order to slide the cover completely rearward along the support portion or either off of the support portion, there must be sufficient space behind the magazine to facilitate the length of the cover when slid rearward along the support portion. In cramped spaces, there is typically an insufficient amount of space behind the magazine to allow the cover to completely slide rearward. Also, with the magazine open, the nailer may be unwieldy. Fasteners typically can not be loaded into magazines if covers thereof can not slide completely rearward.

In some conventional nailers, it is typically up to the operator to monitor the fastener content of the magazine and to reload the magazine when the magazine is low on fasteners. Often times, an operator will not monitor the fastener content of the magazine and the magazine will run out of fasteners. Firing a nailer without firing any fasteners can damage the workpiece surface and waste valuable time of the operator.

In some aspects and in some constructions, the invention provides a nailer, such as a pneumatic nailer, that generally includes a bumper disposed therearound to decrease the force of unwanted impacts on the nailer caused by, for example, dropping the nailer, setting down the nailer, etc.

Also, in some aspects and in some constructions, the invention provides a power tool including a housing including a wall defining a cavity, an aperture being defined through the wall and being in fluid communication with the cavity to facilitate fluid flow from within the cavity, through the aperture and to the exterior of the power tool, a deflector connected to the housing and, in a position, at least partially covering the aperture, the deflector being selectively movable relative to the housing between a first position, in which the deflector deflects fluid flowing through the aperture in a first direction, and a second position, in which the deflector deflects fluid flowing through the aperture in a second direction, and a detent arrangement provided between the housing and the deflector to releasably hold the deflector in at least one of the first position and the second position.

In addition, in some aspects and in some constructions, the invention provides a nailer for driving a fastener from a strip of fasteners, the nailer including a housing defining a firing channel, a magazine connected to the housing, the magazine being operable to support the strip of fasteners in an orientation therein such that the strip of fasteners is advancable toward the firing channel, the magazine defining an insertion opening therein through which the strip of fasteners is insertable into the magazine, the insertion opening having a configuration, and a drive assembly at least partially supported by the housing for driving a fastener positioned in the firing channel into a workpiece, wherein the strip of fasteners has a configuration complementary to the configuration of the insertion opening such that the strip of fasteners insertable into the magazine only when the strip of fasteners is in the orientation.

Further, in some aspects and in some constructions, the invention provides a nailer, such as a pneumatic nailer, that generally includes a nose-lockout switch engageable by collation material of a bundle of fasteners. In such aspects and in such constructions, generally, when the bundle of fasteners is properly inserted into the magazine, the collation material is engageable with the nose lockout switch to release the nose-lockout switch and allow firing of the nailer. Also, in such aspects and in such constructions, the nose-lockout switch is operable to lockout the nailer and to prevent firing thereof when the collation material does not engage the nose-lockout switch. In addition, in such aspects and in such constructions, the collation material does not engage the nose-lockout switch when the bundle of fasteners is incorrectly inserted into the magazine.

Also, in some aspects and in some constructions, the invention provides a nailer, such as a pneumatic nailer, that generally includes a magazine operable to engage collation material of a bundle of fasteners to support the bundle of fasteners within the magazine.

In addition, in some aspects and in some constructions, the invention provides a nailer, such as a pneumatic nailer, that generally includes a magazine having a support portion and a cover. In such aspects and in such constructions, generally, the cover is slidable and rotatable relative to the support portion.

Further, in some aspects and in some constructions, the invention provides a power tool including a housing defining a firing channel, a magazine connected to the housing and operable to support fasteners therein, the magazine including a pusher engaging the fasteners to move the fasteners through the magazine and toward the firing channel, a drive assembly at least partially supported by the housing for driving a fastener positioned in the firing channel into a workpiece, and a lever engageable with the pusher to prevent the power tool from driving a fastener when a quantity of fasteners in the magazine is below a number of fasteners.

Also, in some aspects and in some constructions, the invention provides a strip of fasteners for use with a nailer, the nailer being operable to drive a fastener from said strip of fasteners, the nailer including a housing defining a firing channel, a magazine connected to the housing, the magazine being operable to support said strip of fasteners in an orientation therein such that said strip of fasteners is advancable toward the firing channel, the magazine defining an insertion opening therein through which said strip of fasteners is insertable into the magazine, the insertion opening having a configuration, and a drive assembly at least partially supported by the housing for driving a fastener positioned in the firing channel into a workpiece, said strip of fasteners including a plurality of fasteners, and a collation strip engageable with and securing the plurality of fasteners in said strip of fasteners, said strip of fasteners having a configuration complementary to the configuration of the insertion opening such that said strip of fasteners insertable into the magazine only when said strip of fasteners is in the orientation.

Independent features and independent advantages of the present invention will become apparent to those skilled in the art upon review of the following detailed description, claims and drawings.

### BRIEF DESCRIPTION OF THE DRAWINGS

FIG. 1 is a right perspective view of a nailer, such as a pneumatic nailer.

FIG. 2 is another right perspective view of the nailer shown in FIG. 1.

FIG. 3 is a left perspective view of the nailer shown in FIG. 1.

FIG. 4 is another left perspective view of the nailer shown in FIG. 1.

FIG. 5 is a right side view of the nailer shown in FIG. 1.

FIG. 6 is a left side view of the nailer shown in FIG. 1.

FIG. 7 is a top view of the nailer shown in FIG. 1.

FIG. 8 is a bottom view of the nailer shown in FIG. 1.

FIG. 9 is a front view of the nailer shown in FIG. 1.

FIG. 10 is a rear view of the nailer shown in FIG. 1.

FIG. 11 is a cross-sectional view of the nailer shown in FIG. 1, taken along line 11-11 in FIG. 10.

FIG. 12 is an exploded right perspective view of the nailer shown in FIG. 1.

FIG. 13 is a partial right perspective view of the nailer shown in FIG. 1 and an air deflector of the nailer.

FIG. 14 is a perspective view of the air deflector shown in FIG. 13.

FIG. 15 is an exploded right perspective view of a cap and the air deflector of the nailer shown in FIG. 1.

FIG. 16 is a right perspective view of a second construction of a magazine of the nailer shown in FIG. 1, shown with a cover and a support portion of the magazine connected together.

FIG. 17 is a right perspective view of the magazine shown in FIG. 16, shown with the cover slid rearwardly relative to the support portion.

FIG. 18 is a right perspective view of the magazine shown in FIG. 16, shown with the cover slid rearwardly and rotated relative to the support portion.

FIG. 19 is a right perspective view of the magazine shown in FIG. 16, shown with the cover connected to the support portion and fasteners loaded therebetween.

FIG. 20 is a right perspective view of a pusher of the magazine shown in FIG. 16.

FIG. 21 is a partial left bottom perspective view of the pusher and a connecting spring of the magazine shown in FIG. 16, shown with the pusher engaging the connecting spring.

FIG. 22 is a partial right bottom perspective view of the pusher and connecting spring of the magazine shown in FIG. 16, shown with the pusher engaging the connecting spring.

FIG. 23 is a partial perspective view of fasteners and collation material useable with the nailer shown in FIG. 1.

FIG. 24 is a front view of the fasteners and collation material shown in FIG. 23.

FIG. 25 is a partial right bottom perspective view of a magazine of the nailer shown in FIG. 1, the magazine shown with an insertion opening in a rearward end thereof.

FIG. 26 is a partial left bottom perspective view of the magazine shown in FIG. 25, shown with fasteners being correctly inserted through the insertion opening.

FIG. 27 is a partial right bottom perspective view of a magazine and fasteners incorrectly inserted into the magazine.

FIG. 28 is a partial right bottom perspective view of the magazine shown in FIG. 27 and fasteners incorrectly inserted into the magazine.

FIG. 29 is a partial bottom perspective view of the magazine shown in FIG. 25 and fasteners having the collation material shown in FIGS. 23-24, the collation material preventing incorrect insertion of the fasteners into the magazine.

FIG. 30 is a partial bottom perspective view of the magazine shown in FIG. 25 and fasteners having the collation material shown in FIGS. 23-24, the collation material preventing incorrect insertion of the fasteners into the magazine.

FIG. 31 is a partial bottom perspective view of the magazine shown in FIG. 25 and fasteners having the collation material shown in FIGS. 23-24, the collation material preventing incorrect insertion of the fasteners into the magazine.

FIG. 32 is a partial cross-sectional view of the nailer shown in FIG. 1, shown with a fastener positioned in a firing channel.

FIG. 33 is a top schematic view of fastener having collation material, the firing channel, a first lever and a nose-lockout assembly shown in a locked position.

FIG. 34 is a top schematic view of the fastener, the collation material, the firing channel, the first lever and the nose-lockout assembly shown in FIG. 33, shown in an unlocked position.

FIG. 35 is a cross sectional view of a magazine of the nailer shown in FIG. 1, shown with collation material engaging interior surfaces of the magazine to support the fasteners within the magazine.

FIG. 36 is a right perspective view of a second construction of a nailer, such as a pneumatic nailer.

FIG. 37 is another right perspective view of the nailer shown in FIG. 36.

FIG. 38 is a left perspective view of the nailer shown in FIG. 36.

FIG. 39 is another left perspective view of the nailer shown in FIG. 36.

FIG. 40 is a right side view of the nailer shown in FIG. 36.

FIG. 41 is a left side view of the nailer shown in FIG. 36.

FIG. 42 is a top view of the nailer shown in FIG. 36.

FIG. 43 is a bottom view of the nailer shown in FIG. 36.

FIG. 44 is a front view of the nailer shown in FIG. 36.

FIG. 45 is a rear view of the nailer shown in FIG. 36.

FIG. 46 is an exploded perspective view of the nailer shown in FIG. 36.

FIG. 47 is a cross-sectional view of the nailer shown in FIG. 36, taken along line 47-47 in FIG. 45.

FIG. 48 is a perspective view of an alternative construction of a magazine of a nailer.

FIG. 49 is a perspective view of the magazine shown in FIG. 48, shown with a cover of the magazine removed.

FIG. 50 is a front perspective view of a storage portion of the magazine shown in FIG. 48.

FIG. 51 is a left perspective view of the storage portion of the magazine shown in FIG. 48.

FIG. 52 is a rear perspective view of the storage portion of the magazine shown in FIG. 48.

FIG. 53 is a perspective view of a nail useable with the nailers shown in FIGS. 1 and 36.

FIG. 54 is a top view of the nail shown in FIG. 53.

FIG. 55 is a top view of an alternative construction of an indicia of the nail shown in FIG. 53.

FIG. 56 is a top view of an alternative construction of an indicia of the nail shown in FIG. 53.

FIG. 57 is a top view of an alternative construction of an indicia of the nail shown in FIG. 53.

FIG. 58 is a top view of an alternative construction of an indicia of the nail shown in FIG. 53.

Before at least one embodiment of the invention is explained in detail, it is to be understood that the invention is not limited in its application to the details of the constructions and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION

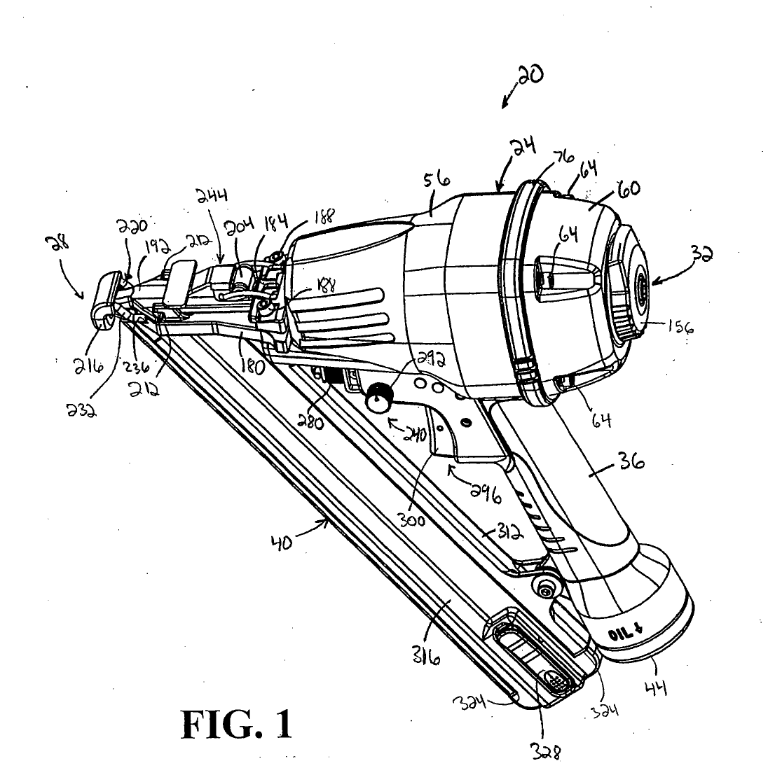

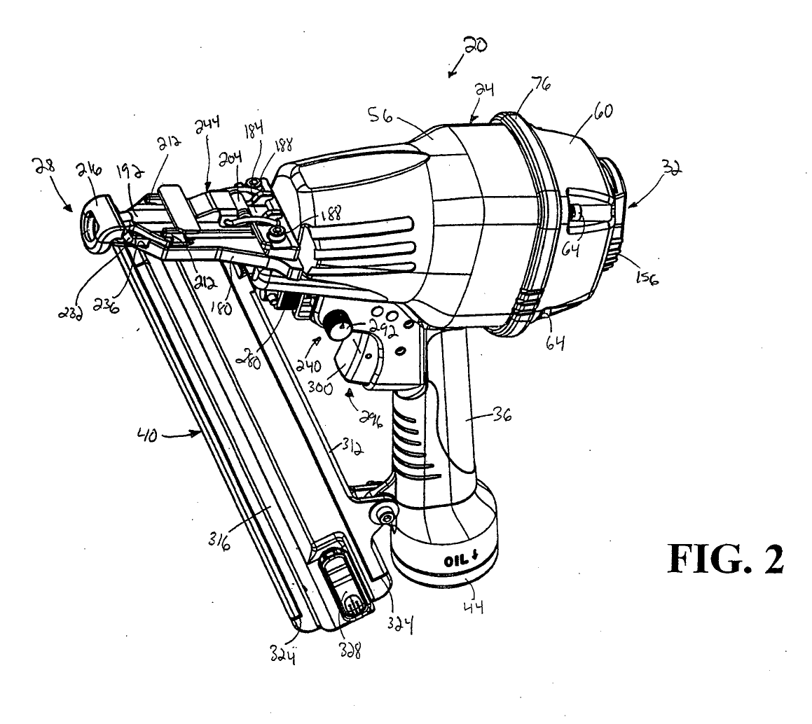

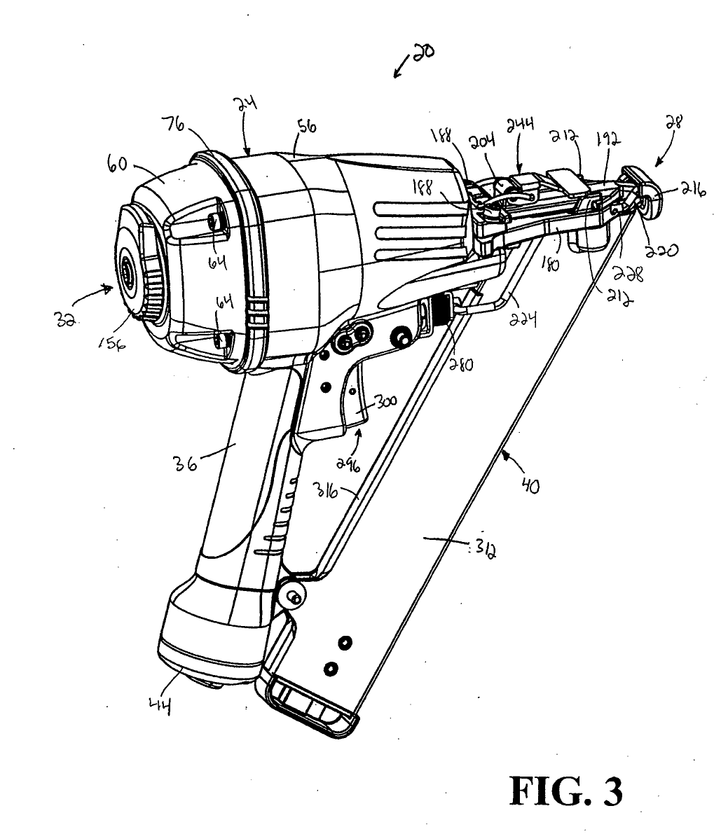

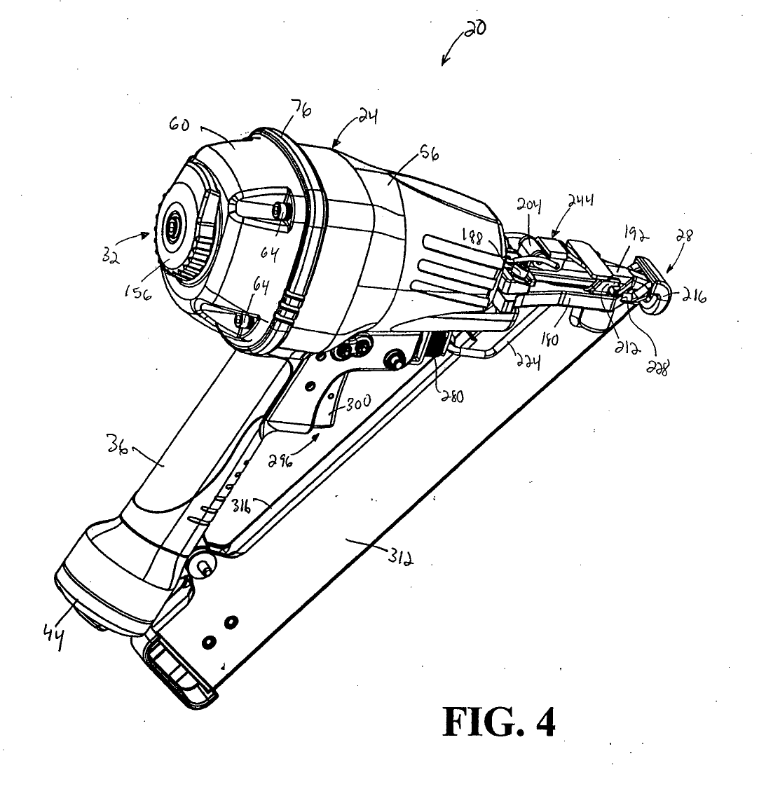

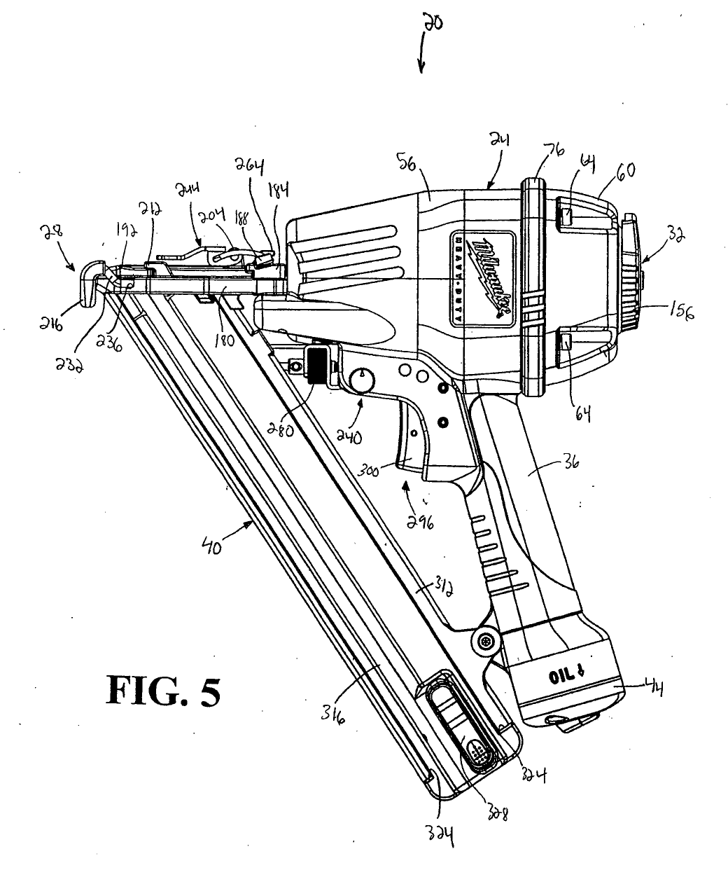

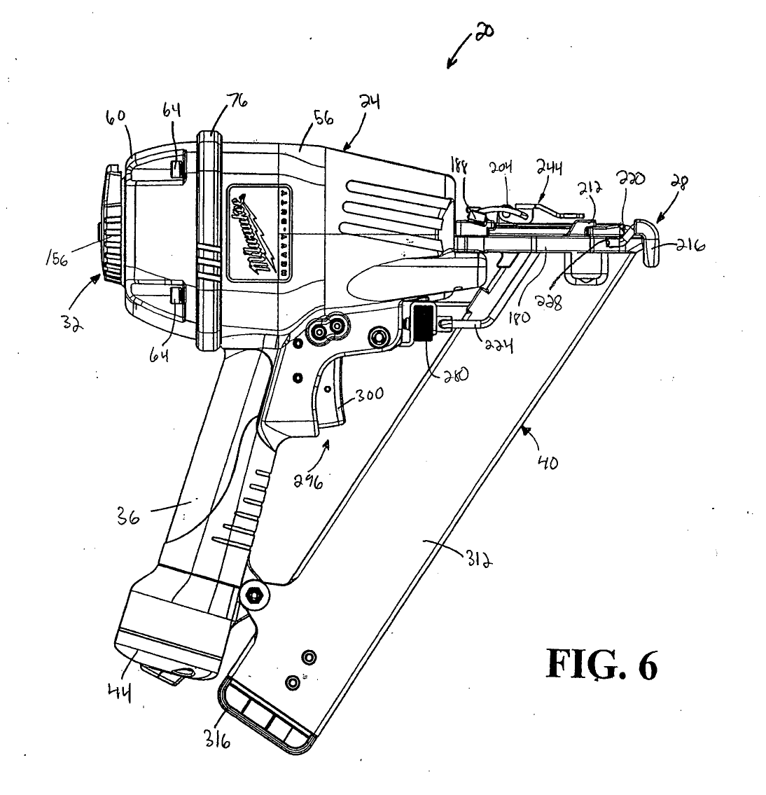

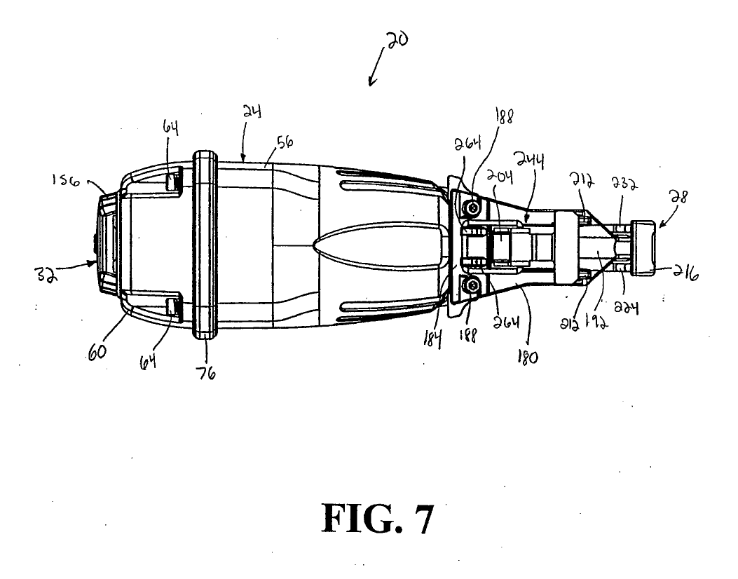

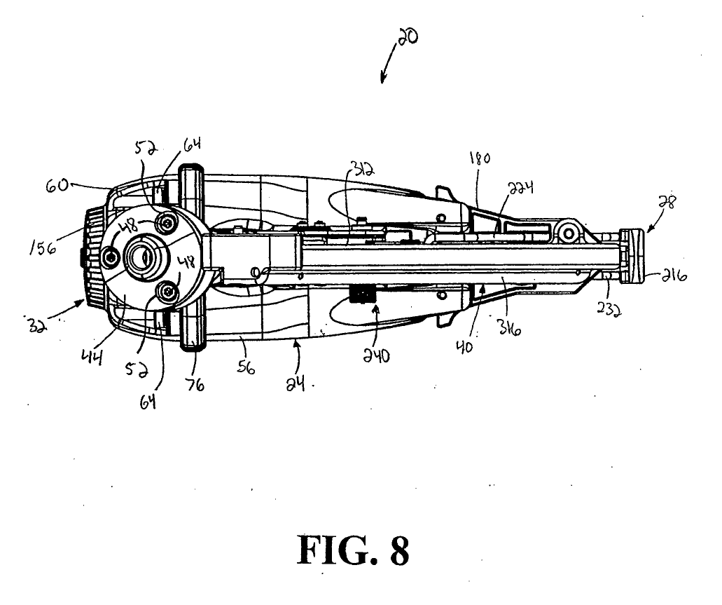

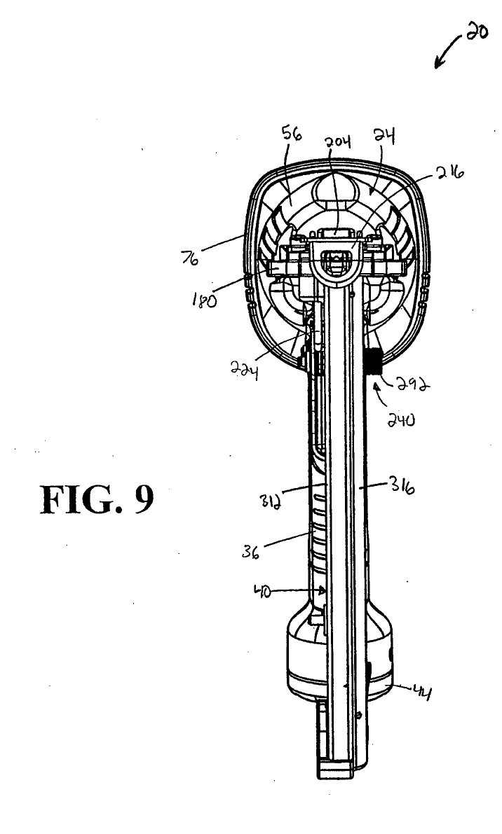

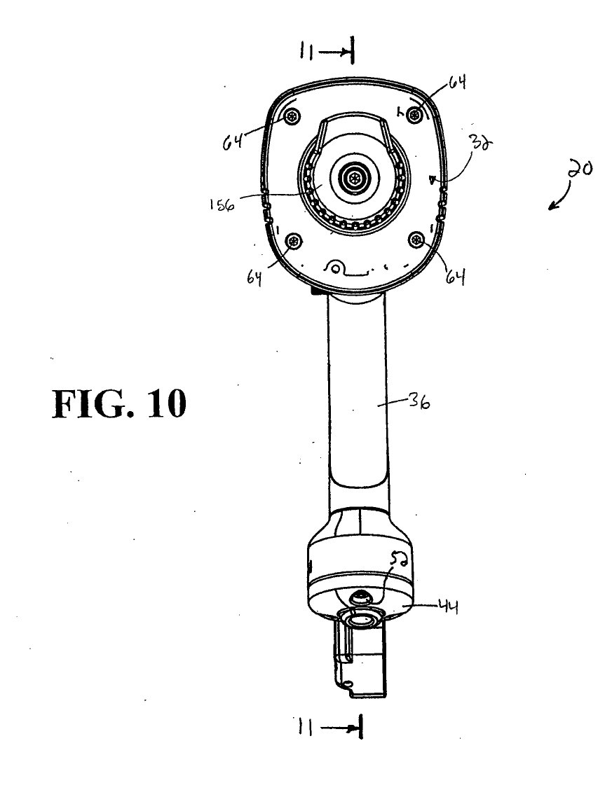

A power tool, such as a pneumatic air-powered nailer 20, embodying independent aspects of the present invention, is illustrated in FIGS. 1-15. It should be understood that, in other constructions and in other aspects, the power tool can be another type of nailers, such as, for example, a combustion nailer, an electric powered nailer, etc. Also, it should be understood that, in other constructions and in other aspects, the power tool can be another type of power tool, such as, for example, a drill, a screwdriver, a saw, etc.

Referring to FIGS. 1-12, the nailer 20 is a “finish”-type nailer and includes a body 24 having a forward end 28 and a rearward end 32, a handle 36 extending from the rearward end 32 and a magazine 40 connected to the forward end 28 and the handle 36. A coupling 44 is positioned at an end of the handle 36 to couple a supply line (not shown), which supplies air from a pneumatic source (not shown), to the nailer 20. Connecting members 48 are disposed on the handle 36 and are receivable within apertures 52 defined in the coupling 44 to connect the handle 36 and the coupling 44. A gasket is disposed between the handle 36 and the coupling 44 to create an effective seal therebetween. In some constructions and in some aspects of the invention, the handle 36 and the coupling 44 can be connected in other manners, such as, for example any type of fastener, resilient clamps, integrally formed, etc., and still be within the spirit and scope of the present invention.

Referring to FIGS. 1-15, the rearward end 32 of the body 24 includes a housing 56 and a cap 60 removably connected to the housing 56 to allow access to the interior of the body 24. Connecting members 64 of the housing 56 are engageable within apertures 68 defined in the cap 60 to connect the housing 56 and cap 60 together. A gasket 72 is positioned between surfaces of the housing 56 and the cap 60 to create an effective seal therebetween. In some constructions and in some aspects of the present invention, the housing 56 and cap 60 can be connected in other manners, such as, for example any type of fastener, resilient clamps, integrally formed, etc.

In the illustrated construction and in some aspects, the nailer 20 also includes a bumper 76 disposed around the connection point between the housing 56 and the cap 60. A raised lip 80 extends outwardly from the housing 56 and engages the bumper 76 to secure the bumper 76 in place. In some aspects, the nailer 20 does not include a raised lip and the bumper 76 is resiliently secured around the connection point between the housing 56 and the cap 60. The bumper 76 can be made of many resilient materials, such as, for example, plastic and rubber, and the bumper 76 can slide onto and off of the raised lip 80 to cover and expose, respectively, the connection point between the housing 56 and the cap 60.

Resiliency of the bumper 76 also allows the bumper 76 to absorb unwanted forces exerted thereto. These unwanted forces can be caused by, for example, setting the nailer 20 on a surface, dropping the nailer 20, stepping on the nailer 20 and other impacts that can occur. In some aspects, the raised lip 80 extends from the cap 60 rather than the housing 56. In some aspects, the bumper 76 can be integrally formed with or rigidly connected to one of the housing 56 and the cap 60. In some aspects, the bumper 76 can include an internally extending flange that is positionable between surfaces of the housing 56 and the cap 60 and is pinched therebetween to secure the bumper 76 in place. In such aspects, the bumper 76 is removable when the housing 56 and the cap 60 are disconnected and the internally extending flange can substitute for the gasket to create an effective seal between the housing 56 and the cap 60.

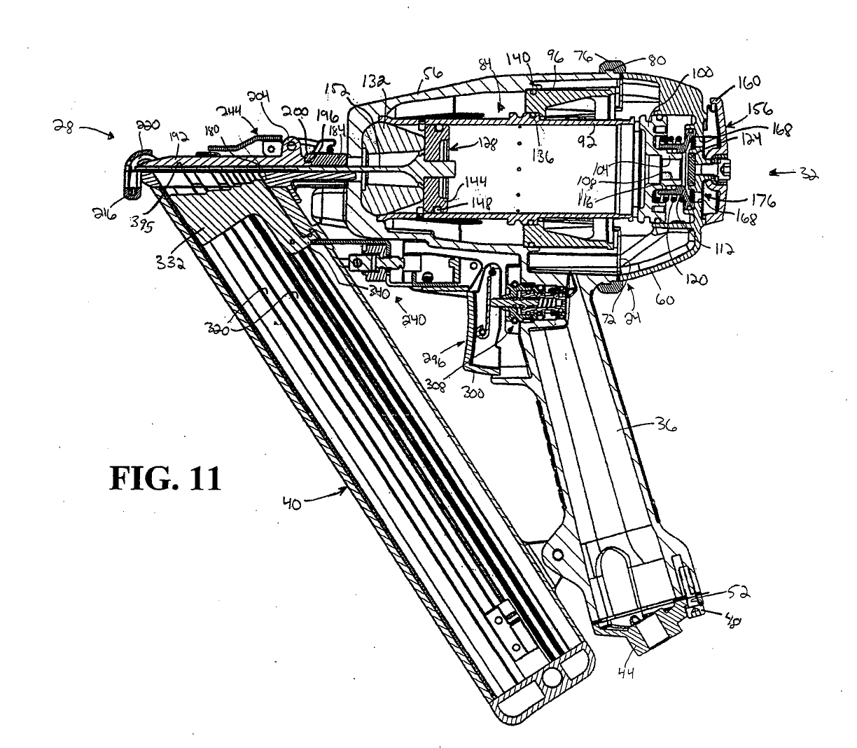

With continued reference to FIGS. 1-15, a drive assembly 84 is disposed substantially within the rearward end 32 of the body 24 and is operable to drive fasteners 88 supported by the magazine 40 (discussed in greater detail below). The drive assembly 84 includes a cylinder 92, a cylinder ring 96 disposed around the cylinder 92 (see FIG. 11), a piston head valve 100 positioned at a rear end of the cylinder 92 that includes a nozzle 104 and a cavity 108 defined through the piston head valve 100 and the nozzle 104, a piston stopper 112 defining a cavity 116 therethrough that receives the nozzle 104 therein, a head valve spring 120 disposed between the piston head valve 100 and the piston stopper 112, a seal 124 positioned between the nozzle 104 and a rear wall of the cap 60, a driver 128 positioned within the cylinder 92 and slidable therein between a rearward position and a forward position, and a cylinder bumper 132 concentrically aligned with the cylinder 92 and positioned between a front end of the cylinder 92 and a forward wall of the housing 56. The cylinder ring 96 is sealingly engageable with both the cylinder 92 and an inner surface of the housing 56 via gaskets or o-rings 136, 140 (see FIG. 11), respectively. The driver 128 includes a piston 144 sealingly engageable with an inner surface of the cylinder 92 via a gasket or O-ring 148 (see FIG. 11) and a driver blade 152 extending forward from the piston 144. The piston 144 receives the force exerted by air from the pneumatic source and drives the driver blade 152 into engagement with fasteners 88 to drive the fasteners 88 into a workpiece. Movement of the driver 128 from the rearward position to the forward position is known as the power stroke. Forward movement of the driver 128 is limited by the cylinder bumper 132.

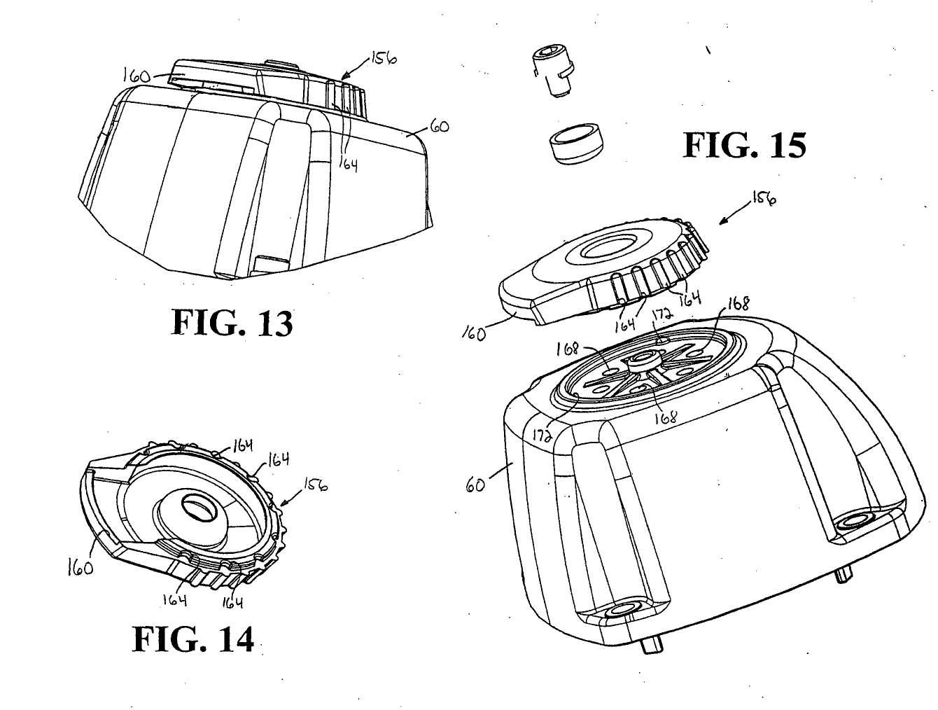

With continued reference to FIGS. 1-15 and, particularly, to FIGS. 13-15, in the illustrated construction and in some aspects, the nailer 20 also includes an air deflector 156 for selectively deflecting air exhausted from the interior of the body 24 to the exterior of the body 24. The deflector 156 defines a deflector nozzle 160 through which air is exhaustible and includes a plurality of detents or recesses 164 defined therearound. The cap 60 defines a plurality of apertures 168 through a rear wall thereof, through which air is flowable from the interior of the body 24, and at least one protrusion 172 (see FIG. 15) complementary to the recesses 164 defined in the deflector 156. Air flowing through the plurality of apertures 168 flows through the deflector nozzle 160 and out of the body 24.

The deflector 156 is rotatably connected to the cap 60 and is selectively positionable in a plurality of positions by rotating the deflector 156 and positioning the protrusion 172 in one of the plurality of recesses 164 defined in the deflector 156. The number of deflector positions is determined by the number of recesses 164 defined in the deflector 156. The position to which the air is deflected by the deflector 156 may be adjusted without any separate tools, and the engagement between the protrusion 172 and one of the recesses 164 holds the deflector 156 in the selected deflection position. In the illustrated construction, the protrusion 172 is biased into engagement with the selected recess 164 by the resilience of the material of protrusion 172 and cap 60 and of the deflector 156.

In other constructions (not shown), the protrusion may be a separate member, and a biasing member, such as, for example, a spring or other flexible member or material, may be positioned between the deflector 156 and the protrusion 172 to bias the protrusion 172 into engagement with the selected recess 164. In some aspects, the deflector 156 can be connected to the cap 60 in a different manner, such as, for example, by complementary geared teeth on the deflector and the cap, by a type of bearing device, etc.

Air is exhausted from the body 24 after the power stroke of the drive assembly 84. To exhaust air, the piston head valve 100 moves toward and engages the cylinder 92. This movement of the piston head valve 100 creates a gap 176 (see FIG. 11) between the top of the piston head valve 100 and the cap 60. Air flows through the gap 176, through the plurality of apertures 168 and is deflected in a desirable direction by the deflector nozzle 156.

Referring back to FIGS. 1-12, a driver nose 180 and a guide cover 184 are positioned at the forward end 28 of the body 24 and are connected to a front of the housing 56 with connecting members 188 similar to connecting members 48, 64. In some constructions and in some aspects, the driver nose 180 and the guide cover 184 can be connected to the front of the housing 56 in other manners, such as, for example, by any type of fastener, by resilient clamps, by being integrally formed, etc. A driver guide 192 is supported on top of the drive nose 180 and includes a lip 196 extending rearwardly that is captured underneath of a protrusion 200 of the guide cover 184. The driver guide 192 also includes a pivot support 204 having a cavity defined therethrough and a pair of angled protrusions 208 that are capturable in slotted support members 212 of the driver nose 180.

A driver pad 216 is positioned at the front of the driver guide 192 and is supported by a first unwanted-firing prevention lever 220 having a first leg 224 supported within a first support channel 228 of the drive nose 180 and a second leg 232 supported within a second support channel 236 of the drive nose 180. The second leg 232 extends rearward and below the drive nose 180 to engage a driver pad adjustment assembly 240 (discussed in greater detail below).

With continued reference to FIGS. 1-12, a driver guide quick release assembly 244 is pivotally connected to the driver guide 192 and selectively connectable to the guide cover 184. The quick release assembly 244 includes a pair of spaced apart flanges 248 defining apertures therethrough. The flanges 248 are positioned on opposite sides of the pivot support 204 such that the apertures align with the cavity defined in the pivot support 204. A shaft 252 is positioned within the apertures and the cavity to pivotally connect the quick release assembly 244 to the driver guide 192. The quick release assembly 244 also includes an actuation lever 256 and a locking member 260, which is engageable with a pair of locking hooks 264 extending upwardly and rearwardly from the guide cover 184.

The quick release assembly 244 has a locked condition, in which the actuation lever 256 is positioned downward toward the driver guide 192 and the locking member 260 is captured behind the locking hooks 264 of the guide cover 184, and an unlocked condition, in which the actuation lever 256 is moved upward away from the driver guide 192 and the locking member 260 is not captured behind the locking hooks 264. In the locked condition, the pair of angled protrusions 208 of the driver guide 192 are captured in the slotted support members 212 of the driver nose 180 and the driver guide 192 is in an appropriate position to facilitate operation of the nailer 20. In the unlocked condition, the pair of angled protrusions 208 are movable out of the slotted support members 212 and the driver guide 192 is movable forward and upward to facilitate removal of jammed, broken, bent or otherwise dysfunctional fasteners from underneath the driver guide 192.

With continued reference to FIGS. 1-12, the adjustment assembly 240 includes a second unwanted-firing prevention lever 268, an adjusting post 272 supported by the second lever 268 and defining an aperture 276 therethrough into which the second leg 232 of the first lever 220 is inserted, an adjusting nut 280 supported by the adjusting post 272, a guide lever 284 supported by the body 24, a mode pin 288 supported by the guide lever 284, and an adjusting button 292 supported on the mode pin 288.

With additional reference to FIGS. 1-12, a trigger assembly 296 is illustrated and includes a trigger 300 pivotally connected to the guide lever 284 via a trigger pin 304 and a trigger valve 308 operable to control air flow into the nailer 20 from the pneumatic source. The trigger 300 is movable between an extended position, in which the trigger valve 308 is closed to prevent air from entering the body 24 of the nailer 20, and a depressed position, in which the valve 308 is open to allow air to enter into the body 24. The trigger 300 is movable from the extended position to the depressed position under manual bias of an operator. In the illustrated construction and in some aspects, the trigger 300 has the appearance of an electric power tool trigger rather than that of a typical pneumatic tool.

The adjusting assembly 240 is operable to switch the operation of the nailer 20 and prevent unwanted firing during operation of the nailer 20. In the illustrated construction, the adjusting assembly 240 switches the nailer 20 between a contact actuation mode (bumpfire), in which the driver pad 216 is pressed against a workpiece and depressed causing the nailer 20 to fire (or drive a fastener into the workpiece), and a sequential actuation mode, in which the trigger 300 must be biased to the depressed position and the driver pad 216 must be depressed at the same time to facilitate firing of the nailer 20 (or driving of a fastener). The adjusting assembly 240 may switch the nailer 20 between other types of operation and still be within the spirit and scope of the present invention.

With further reference to FIGS. 1-12, the magazine 40 includes a support portion 312 and a cover 316 slidably connected to the support portion 312. The support portion 312 is connected at one end to the handle 36 and at a second end to the forward end 28 of the body 24. A plurality of parallel grooves 320 is defined along substantially the entire length of the support portion 312 and are operable to receive heads of fasteners 88 and/or collation material therein. The plurality of grooves 320 allow the magazine 40 to facilitate varying lengths of fasteners 88 therein. Collation material is used to secure the fasteners 88 together in a bundle, stick, section, row or strip to eliminate single loading of fasteners 88 into the magazine 40. As described herein, a plurality of fasteners 88 secured together by collation material will be referred to as a row of fasteners 88, however, the plurality of fasteners 88 secured together by collation material can also be referred to as a strip of fasteners 88. Row and strip are interchangeable with each other when referring to the plurality of fasteners 88 secured together by the collation material.

The support portion 312 also defines guide slots 324 therein for receiving edges of the cover 316. The cover 316 is slidable along the guide slots 324 between a locked position, in which the cover 316 is positioned to cover the support portion 312 and is locked to the support portion 312 via a magazine latch 328, and an unlocked position, in which the cover 316 is slid rearward along the support portion 312 to enable loading and unloading of fasteners 88 from the magazine 40. To move the cover 316 from the locked position to the unlocked position, the magazine latch 328 is activated to disengage the support portion 312 and allow movement of the cover 316 relative to the support portion 312. In some aspects, the magazine 40 includes stops (not shown) positioned in the guide slots 324 to limit the rearward movement of the cover 316 along the support portion 312 and prevent the cover 316 from sliding completely off of the support portion 312. In some aspects, the cover 316 is slidable completely off of the support portion 312.

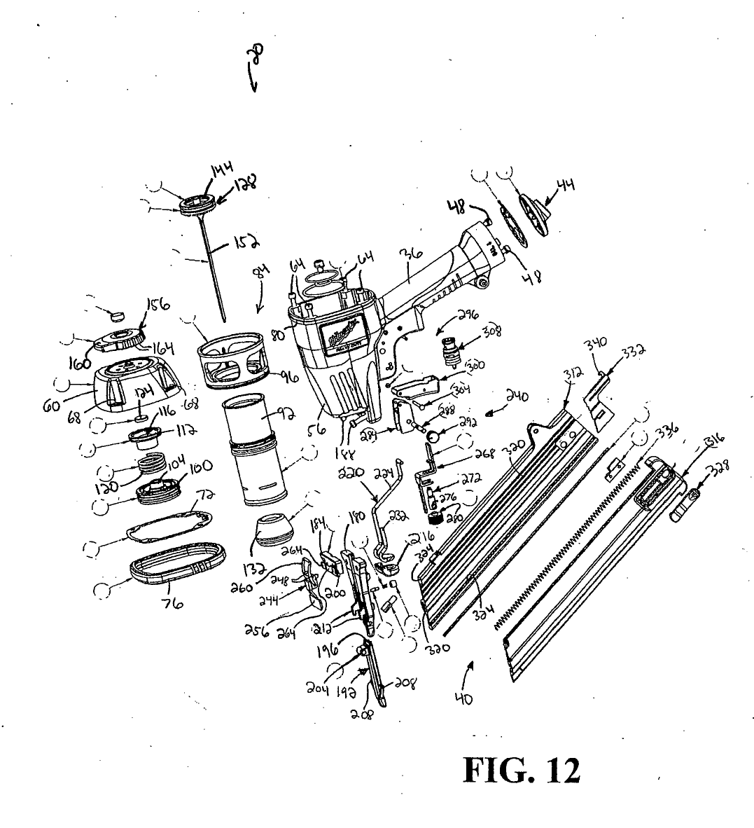

A pusher 332 is positioned between the support portion 312 and the cover 316 and is engageable with fasteners 88 to bias fasteners 88 toward a loading position, in which a fastener 88 is driveable by the drive assembly 84 into a workpiece. A pusher spring 336 (see FIG. 12) is disposed within the magazine 40 and engages a rear of the pusher 332 to bias the pusher 332 toward the loading position, and therefore, bias fasteners 88 toward the loading position.

With particular reference to FIG. 11, a portion of the second lever 268 is positioned within the magazine 40 and is engageable by a horn or hook portion 340 of the pusher 332. The hook portion 340 engages the second lever 268 when the level of fasteners 88 within the magazine 40 is low (e.g., five or fewer fasteners). Engagement between the pusher 332 and the second lever 268 prevents the nailer 20 from firing when the nailer 20 is low on fasteners 88. When the pusher 332 engages the second lever 268, the magazine 40 must be loaded with additional fastener 88 in order for the nailer 20 to operate.

To load fasteners 88 into the magazine 40, the magazine latch 328 is activated and the cover 316 is slid rearward along the support portion 312. In some aspects, the pusher 332 slides rearward with the cover 316 to position the pusher 332 at a rear of the support portion 312 and allow fasteners 88 to be inserted in front of the pusher 332. In some aspects, the pusher 332 is manually slid rearward separate from the cover 316. As discussed above, the cover 316 can be slid completely off of the support portion 312 or the cover 316 can engage the stops positioned in the guide slots 324. After the pusher 332 is slid rearward along the support portion 312, fasteners 88 are loaded in front of the pusher 332 and into engagement with the support portion 312. The cover 316 is then slid forward to the locked position where the cover 316 covers the fasteners 88 and secures the fasteners 88 in the magazine 40.

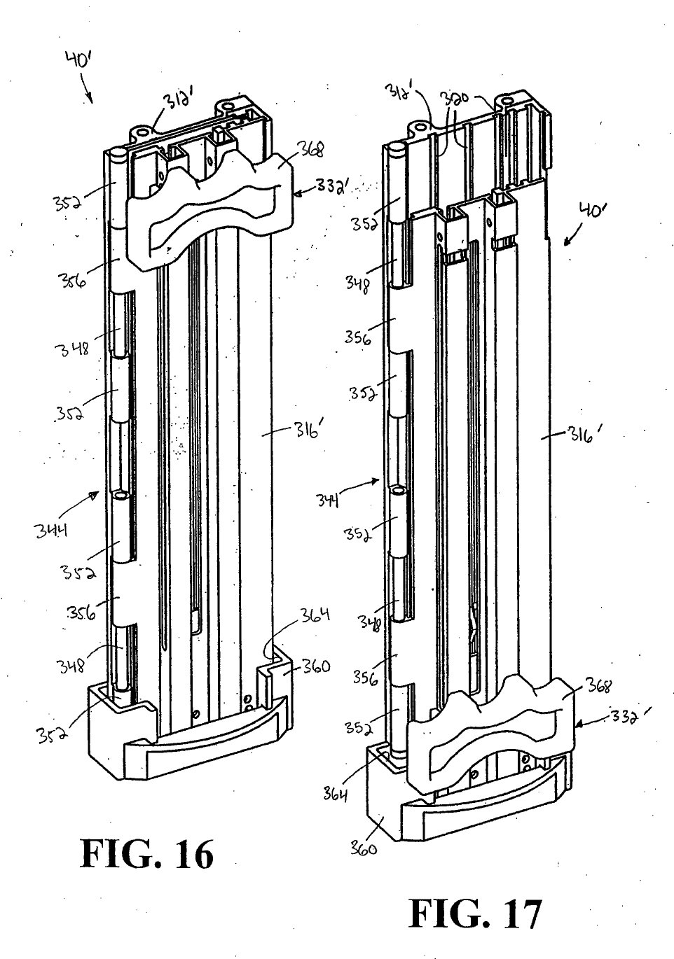

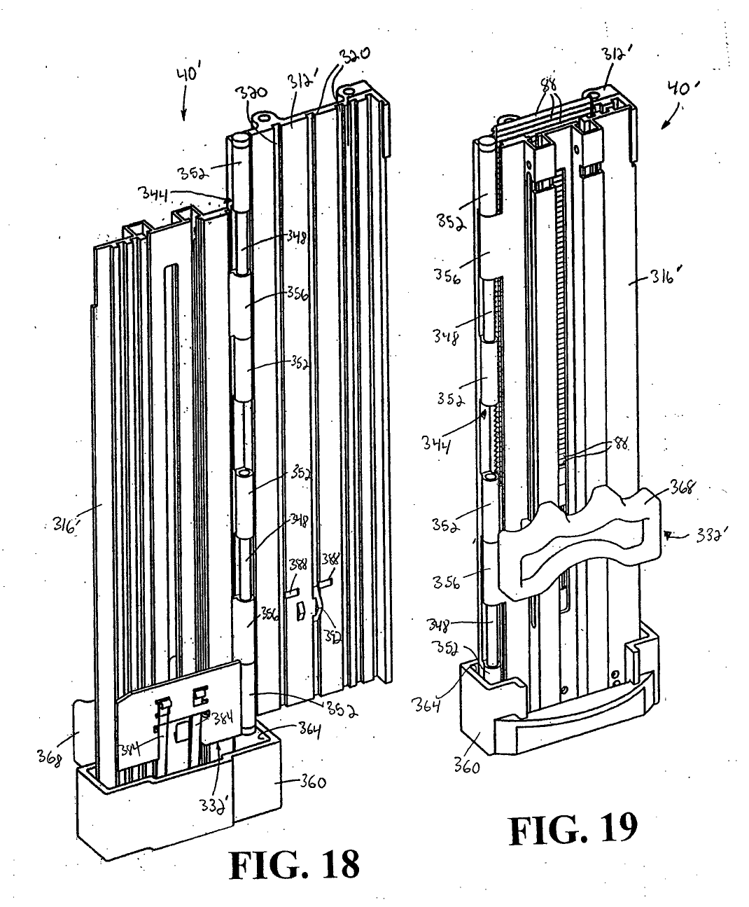

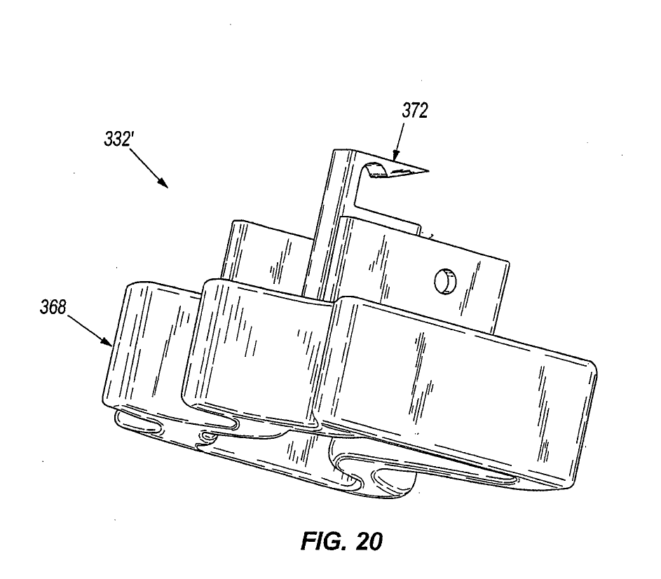

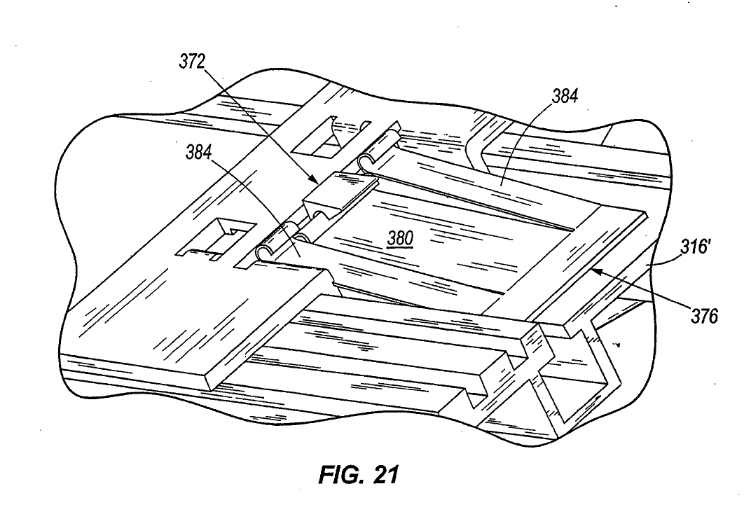

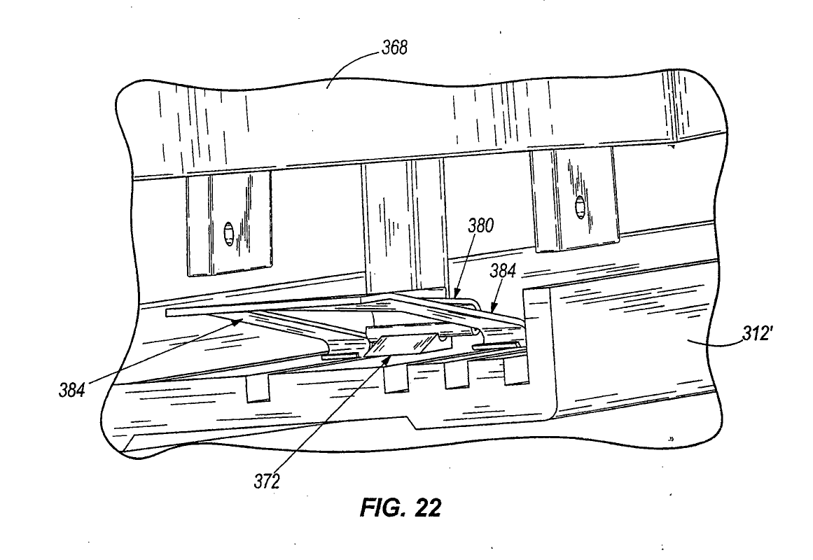

Referring to FIGS. 16-22, a second construction of the magazine 40 is illustrated. Common elements are identified by the same reference numbers “′”.

The magazine 40′ includes a support portion 312′ and a cover 316′ connected to each other via a hinge assembly 344, which allows the cover 316′ to slide and rotate relative to the support portion 312′. The hinge assembly 344 includes a pair of substantially co-axial rods 348 press-fit into flanges 352 of the support portion 312′. Flanges 356 of the cover 316′ are disposed around the rods 348 and are slidable therealong and rotatable thereabout. In some aspects, a single rod is used rather than a pair of rods. An end cap 360 is connected to an end of the cover 316′ and defines a cavity 364 within which the end of the cover 316′ and an end of the support portion 312′ are positionable. A pusher 332′ is slidably connected to the cover 316′ and includes a handle 368 manipulateable by an operator and a hook 372. The pusher 332′ is biased toward the loading position by a spring (not shown).

The magazine 40′ also includes a connecting spring 376 rigidly connected to the cover 316′ and having a central portion 380 and a pair of outer portions 384. The outer portions 384 have curved ends that are insertable into apertures 388 defined in the support portion 312′ to selectively lock the cover 316′ to the support portion 312′ and prevent movement therebetween.

To load the magazine 40′ with fasteners 88′, an operator grasps the handle 368 and biases it rearward against the spring. The hook 372 of the pusher 332′ engages and captures the central portion 380 of the connecting spring 376 to bias the connecting spring 376 away from the support portion 312′ causing the curved ends of the outer portions 384 to move out of the apertures 388 and unlock the cover 316′ and the support portion 312′. When unlocked, the cover 316′ and the support portion 312′ are movable relative to one another. Continued rearward movement of the pusher 332′ causes the pusher 332′, the end cap 360 and the cover 316′ to slide rearwardly together relative to the support portion 312′. The flanges 356 of the cover 316′ slide along the rods 348 until they engage the flanges 352 of the support portion 312′. At this point, the end of the support portion 312′ is not positioned within the cavity 364 of the end cap 360 and the cover 316′ can rotate relative to the support portion 312′. The flanges 356 of the cover 316 rotate about the rods 348 to expose the interior of the magazine 40′.

Fasteners 88′ can be loaded onto the support portion 312′ and the cover 316′ can be rotated back toward the support portion 312′. The pusher 332′, the end cap 360 and the cover 316′ are then slid forward relative to the support portion 312′ to bring the end of the support portion 312′ back into the cavity 364 of the end cap 360. The central portion 380 of the connecting spring 376 engages a ramp 392 protruding from the support portion 312′ to bias the central portion 380 from behind the hook 340 and release the central portion 380 from the hook 340. Upon release of the central portion 380, the outer portions 384 re-insert into the apertures 388 defined in the support portion 312′ to connect the cover 316′ to the support portion 312′. Also upon release of the central portion 380, the pusher 332′ is biased into engagement with the fasteners 88′ via the spring.

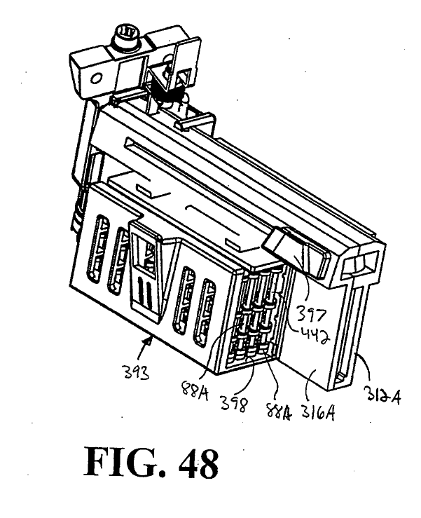

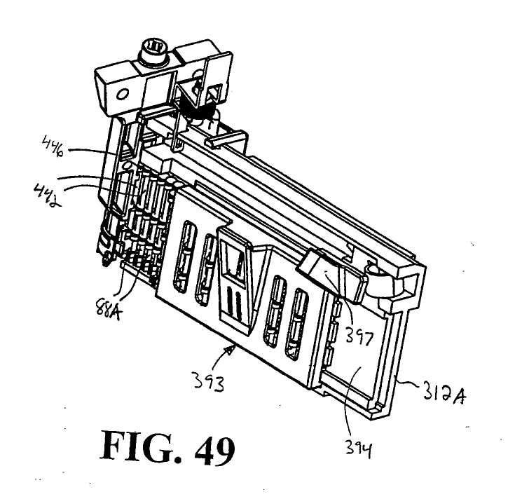

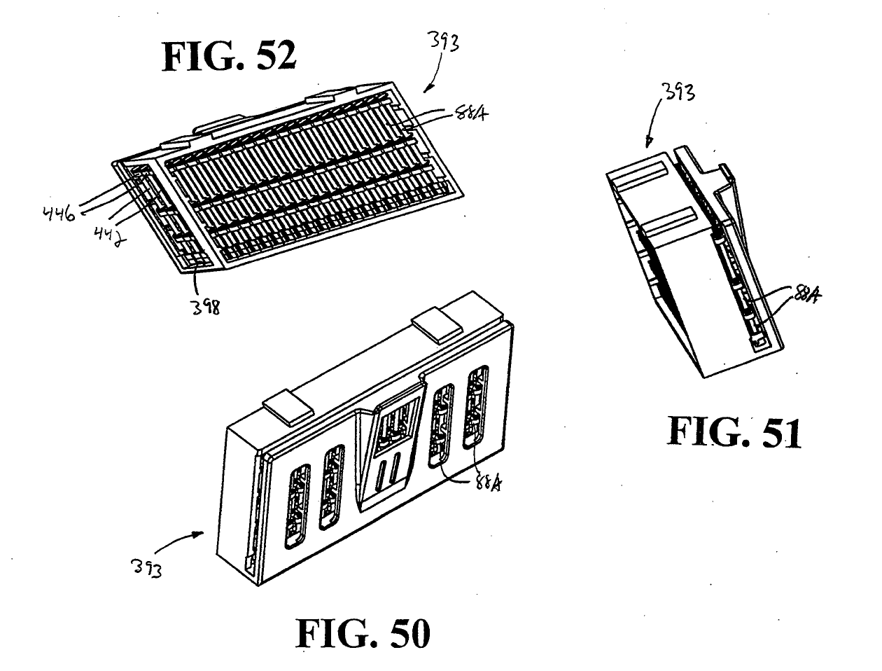

Referring to FIGS. 48-52, a third construction of the magazine 40 is illustrated. Common elements are identified by the same reference numbers “A”.

The magazine 40A is capable of holding multiple rows of fasteners 88A and includes a support portion 312A, a cover 316A connected to the support portion 312A and a storage portion 393 for supporting multiple rows of fasteners 88A. The storage portion 393 extends outwardly from the cover 316A and includes a biasing member (not shown) engaging the outermost row of fasteners 88A (outermost row of fasteners 88A is defined by the row of fasteners furthest from the support portion 312A) in the storage portion 393 and biasing the rows of fasteners 88A positioned within the storage portion 393 toward the support portion 312A of the magazine 40A. A feeding plane 394 is defined between the support portion 312A and the cover 316A. Rows of fasteners 88A are fed along the feeding plane 394 toward the driver nose 180A of the nailer 20A and into a firing channel 395 where the fasteners 88A are driven one-by-one into a workpiece. Rows of fasteners 88A are positioned in the feeding plane 394 when they are biased into contact with the support portion 312A. As discussed above, the rows of fasteners 88A positioned in the feeding plane 394 are biased toward the firing channel 395 by the pusher 332A. The pusher 332A engages the rearmost fastener in the row of fasteners 88A positioned in the feeding plane 394.

The biasing member can take a variety of shapes and have a variety of configurations. In some constructions, the biasing member includes a bar (not shown) engaging the row of fasteners 88A along a substantial length thereof and a spring (not shown) biasing the bar into engagement with the outermost row of fasteners 88A. In other constructions, the biasing member can assume a leaf spring (not shown) type configuration in which the spring includes a member extending therefrom that is under spring force to engage the outermost row of fasteners 88A to move the rows of fasteners 88A toward the feeding plane 394. The biasing member can take any appropriate shape and configuration and be within the spirit and scope of the present invention.

In the illustrated construction, the storage portion 393 can support four additional rows of fasteners 88A in addition to the row of fasteners 88A positioned in the feeding plane 394. However, the support portion 312A can support any number of additional rows of fasteners 88A and still be within the spirit and scope of the present invention.

Now that the components of the magazine 40A have been described, fastener loading operation will be described herein.

As the nailer 20A drives fasteners 88A into a workpiece(s), fasteners 88A are consumed from the row of fasteners 88A positioned in the feeding plane 394 and are continually fed toward the firing channel 395 under the bias of the pusher 332A. Once the row of fasteners 88A positioned in the feeding plane 394 have been sufficiently consumed, the operator grasps a pusher lever 397 and moves the lever 397 and the pusher 332A rearwardly against the bias of the pusher spring 336A. In some constructions, the nailer 20A includes a pusher lock (not shown) that engages either or both the pusher lever 397 and/or the pusher 332A when the pusher lever 397 and the pusher 332A are moved rearwardly and locks the pusher lever 397 and the pusher 332A in a rearward position. When locked in the rearward position, the pusher lever 397 and pusher 332A are unable to move without exterior forces provided by the operator. In other constructions, the pusher lever 397 and the pusher 332A are not locked in a rearward position and must be manually held rearwardly along the magazine 40A. It should be understood that the pusher 332A can automatically move rearward without manipulation by the operator when the fasteners 88A have been sufficiently consumed. In such instances, the pusher 332A can be in pneumatic communication with the nailer 20A and the pneumatic source to pneumatically move the pusher 332A rearwardly. Also in such instances, the pusher 332A can be moved rearwardly by a separate mechanical device (not shown) not associated with the pneumatic source. Further in such instances, the pusher 332A can be spring biased rearwardly to overcome the bias of the pusher spring 336A when the fasteners 88A have been sufficiently consumed.

The pusher 332A is moved rearwardly to a position behind the rearmost fasteners 88A in the storage portion 393 (rearmost fasteners 88A are defined as the fasteners furthest from the firing channel 395). Once the pusher 332A is behind the rearmost fasteners 88A, the rows of fasteners 88A are free to move toward the support portion 312A and the feeding plane 394 under the bias of the biasing member. The row of fasteners 88A nearest to the support portion 312A engages the support portion 312A to be positioned in the feeding plane 394. Now that a row of fasteners 88A is positioned in the feeding plane 394, the pusher 332A can be reengaged with the rearmost fastener in the row of fasteners 88A. The pusher 332A can be unlocked from the rearward position or can be released from operator bias to reengage the rearmost fastener in the row of fasteners 88A. The nailer 20A is then again operated until the fasteners 88A in the row positioned in the feeding plane 394 are sufficiently consumed. The pusher lever 397 and the pusher 332A are again moved rearwardly under the bias of an operator and the next row of fasteners 88A are biased into the feeding plane 394 by the biasing member. The pusher 332A and the pusher lever 397 are again allowed to engage the rearmost fastener to bias the fasteners 88A along the feeding plane 394 toward the firing channel 395. This process continues until all the rows of fasteners 88A are consumed.

The additional rows of fasteners 88A can be loaded into the storage portion 393 in a variety of manners. In some constructions, the storage portion 393 includes a door (not shown) moveable to allow access to the interior of the storage portion 393. In such constructions, the door can be slidable or pivotable to allow access to the interior of the storage portion 393. In other constructions, the rows of fasteners 88A can be inserted through an insertion opening 404A (discussed below) defined in the magazine 40A. Upon insertion of additional rows of fasteners 88A, the previously inserted rows of fasteners 88A move into the storage portion 393. In such constructions, the rows of fasteners 88A can be moved into the storage portion 393 under the bias of the next inserted row of fasteners 88A or under the bias of a separate biasing member (not shown). In further constructions, the storage portion 393 can defines an insertion opening 398 through which rows of fasteners 88A are inserted into the storage portion 393.

It should be understood that the nailer 20A can include other manners of advancing fasteners along the feeding plane 394 and toward the firing channel 395. In some constructions, the nailer 20A includes a pneumatic advancing mechanism (not shown) including a pneumatic cylinder (not shown) in pneumatic communication with the pneumatic source and a feeding member (not shown) connected to and moveable by the cylinder. The feeding member engages at least one of the fasteners 88A in the row of fasteners 88A positioned in the feeding plane 394. After the nailer 20A drives a fastener 88A from the firing channel 395, the cylinder advances the feeding member, and therefore the row of fasteners 88A, toward the firing channel 395 to position the leading fastener 88A in the firing channel 395. The cylinder can advance the fasteners 88A toward the firing channel 395 in a variety of manners. In some constructions, the cylinder and the feeding member moves forward to advance the row of fasteners 88A a single position toward the firing channel and then the cylinder and the feeding member return to their original position prior to advancing the row of fasteners 88A another single position. In other constructions, the cylinder and the feeding member move forward several consecutive times to advance the row of fasteners 88A several consecutive single positions before the cylinder and the feeding member return to their original position for another set of consecutive single advancements of the fasteners 88A.

The advancing mechanism can have a variety of different configurations to enable the feeding member to move rearward and return to its original position without pulling the row of fasteners 88A rearwardly and away from the firing channel 395. In some constructions, the feeding member is moved out of engagement with the fasteners 88A, pulled rearwardly, and reengaged with the row of fasteners 88A in preparation of another advancing motion. In other constructions, the feeding member is pivotally connected to the cylinder and pivots relative to the cylinder and the row of fasteners 88A as the cylinder moves the feeding member rearwardly. The pivoting of the feeding member enables the feeding member to pass by a fastener 88A and return to its original position where it can advance another fastener 88A.

In other constructions of the nailer 20A, the pneumatic advancing mechanism includes a pair of feeding members (not shown) connected to the cylinder. The feeding members are spaced from one another and are engageable with different fasteners. The feeding members are synchronized with each other to advance the row of fasteners 88A positioned in the feeding plane 394 toward the firing channel 395. When the row of fasteners 88A is almost consumed and the last fastener 88A of the row is advanced past the lead fastener 88A of the next row of fasteners 88A stored in the storage portion 393, the next row of fasteners 88A stored in the storage portion 393 moves into the feeding plane 394 immediately behind the substantially consumed row of fasteners 88A. The set of feeding members are configured to engage and advance the substantially consumed row of fasteners 88A with the foremost one of the feeding members and engage and advance the next row of fasteners 88A with the rearmost of the feeding members to ensure that fasteners 88A are continuously advanced into the firing channel 395 without interruption and without a misfire (no fastener fired, which can be caused by a gap between consecutive rows of fasteners 88A). When the substantially consumed row of fasteners has been consumed to the point that it is in front of the foremost feeding member, the foremost feeding member engages the next row of fasteners to advance it forward toward the firing channel and advance the remaining fasteners of the substantially consumed row of fasteners toward the firing channel by advancing the next row of fasteners behind the remaining fasteners. The foremost and rearmost feeding members can both engage the same row of fasteners during a period of operation before the row of fasteners is advanced past the rearmost feeding member. The rearmost feeding member will engage the next row of fasteners stored in the storage portion once the last fastener in the row of fasteners positioned in the feeding plane is advanced past the leading fastener of the next row. This operation continues to consume all the rows of fasteners stored in the storage portion 393 of the magazine 40A. It should be understood that the pneumatic advancing mechanism can include any number of feeding members and still be within the spirit and scope of the present invention.

In further constructions, the nailer 20A can utilize fastener advancing mechanisms similar to the fastener advancing mechanisms disclosed in U.S. patent application Ser. No. 10/730,745, the disclosure of which is hereby incorporated by reference.

It should also be understood that the multiple rows of fasteners 88A positioned in the storage portion 393 can be moved toward the feeding plane 394 in a variety of manners other than the biasing member. In some constructions, the nailer 20A can include a row advancing mechanism (not shown) similar to the pneumatic advancing mechanism discussed above. In such constructions, the row advancing mechanism is in pneumatic communication with the pneumatic source and is operable to advance a row of fasteners 88A positioned in the storage portion 393 toward the feeding plane 394 and retract rearwardly, away from the feeding plane 394, to reposition in preparation of another advancing operation. Alternatively, the row advancing mechanism can engage the outermost row of fasteners 88A and apply a force thereto to advance the rows of fasteners 88A toward the feeding plane 394. In this instance, the row advancing mechanism could continuously advance the rows of fasteners 88A toward the feeding plane 394 until all the rows of fasteners 88A have been consumed. In other words, the row advancing mechanism would not have to retract after each advancing operation.

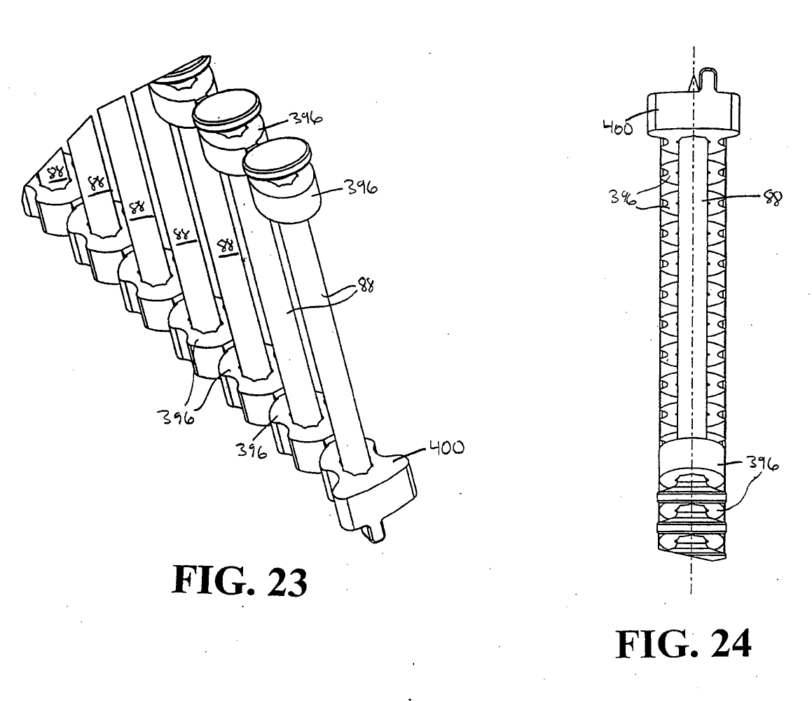

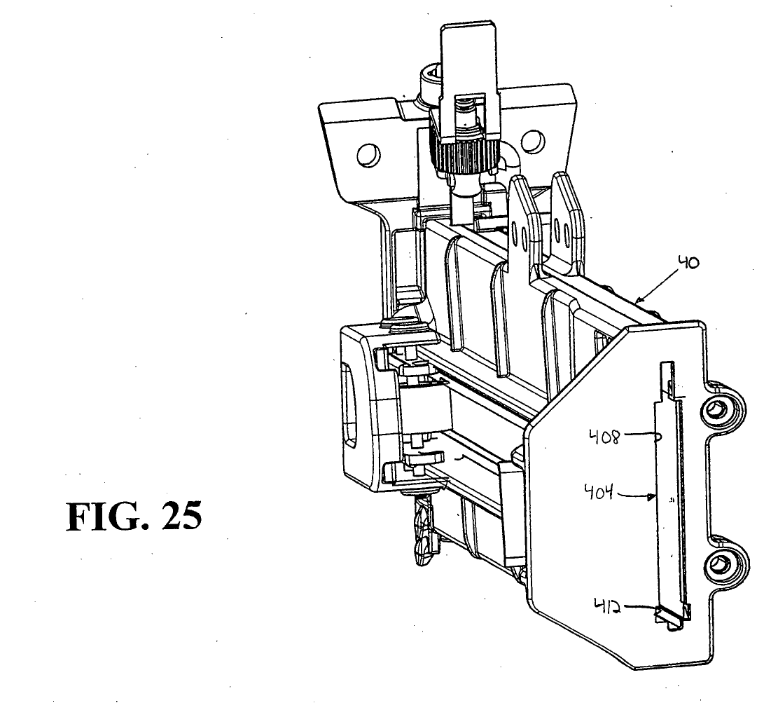

Referring to FIGS. 23-26, in the illustrated construction and in some aspects, the collation material is operable to ensure correct alignment and insertion of the fasteners 88 into the magazine 40. The fasteners 88 can be secured together with a thin collation strip 396 and a wide collation strip 400 that are non-symmetrical with respect to one another. In the illustrated construction, only the last fastener 88 has a wide collation strip 400 (see FIG. 23). In some aspects, all of the fasteners 88 may have wide collation strips 400. However, any number of the fasteners 88 can have wide collation strips 400 and still be within the spirit and scope of the present invention.

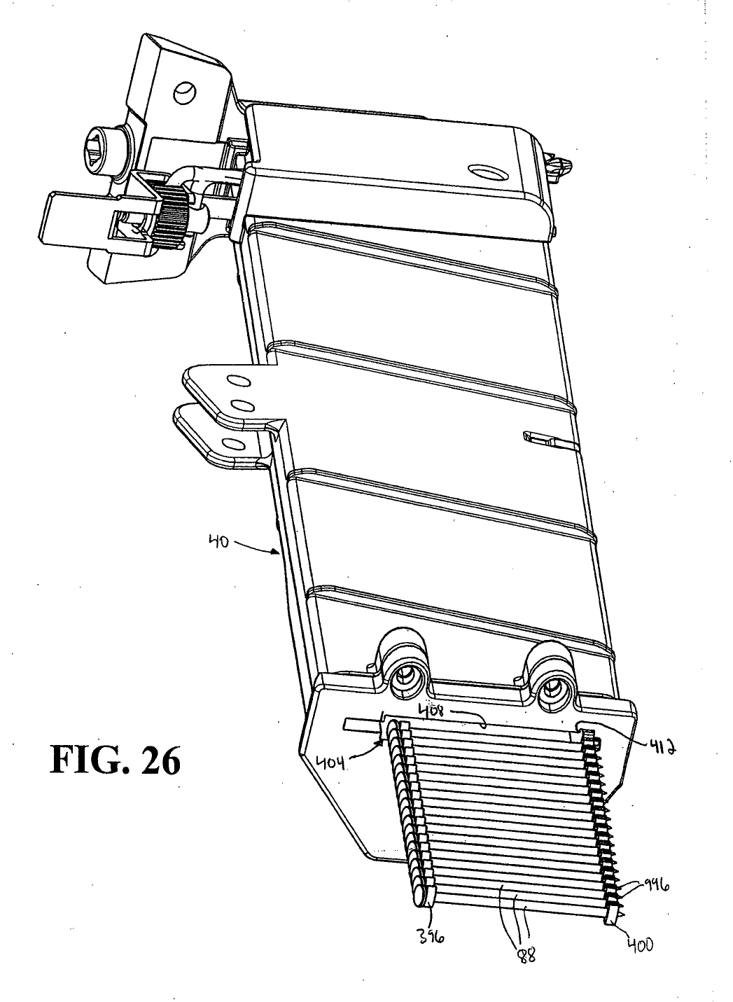

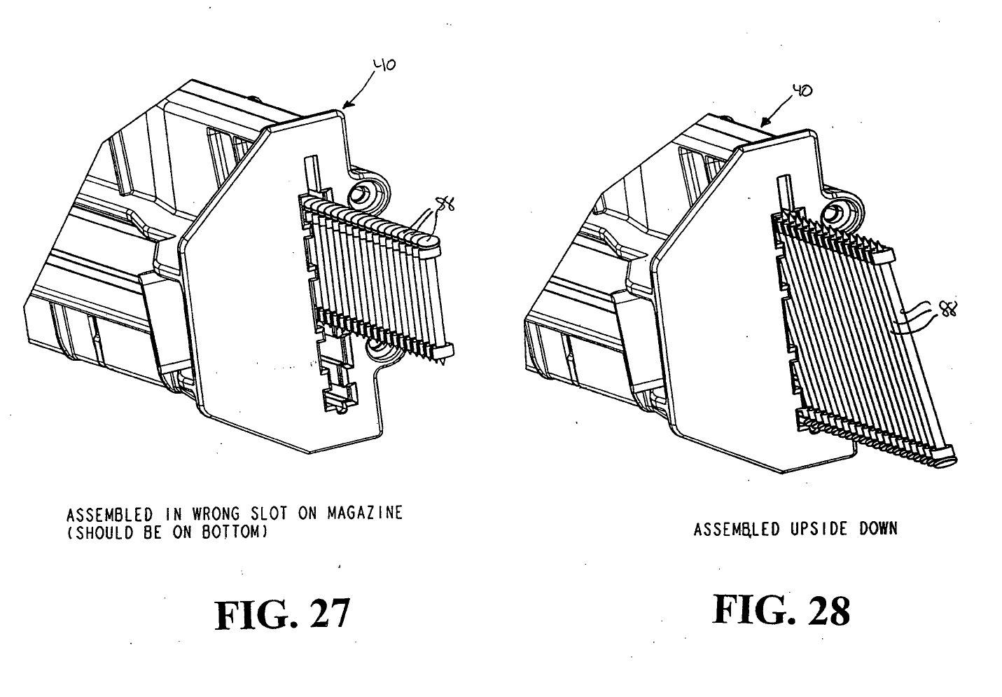

The wide collation strip 400 protrudes further out from the fasteners 88 than the thin collation strip 396. Accordingly, the magazine 40 defines an insertion opening 404 in a rearward end thereof that complements the non-symmetrical shape of the collation strips 396, 400. The insertion opening 404 includes a thin portion 408 and a wide portion 412. The wide portion 412 of the opening 404 is wide enough to allow insertion of the wide collation strip 400 therein and the thin portion 408 is wide enough to allow insertion of the thin collation strip 396 therein, but narrow enough not to allow insertion of the wide collation strip 400 therein. This combination of non-symmetrical collation strips 396, 400 and the thin and wide portions 408, 412 of the insertion opening 404 ensure that the fasteners 88 are inserted into the magazine 40 in the correct orientation (see FIG. 26). As illustrated in FIGS. 27-28, fasteners 88 without the collation strips 396, 400 and the insertion opening 404 having complementary thin and wide portions 408, 412 can be incorrectly inserted into the magazine 40.

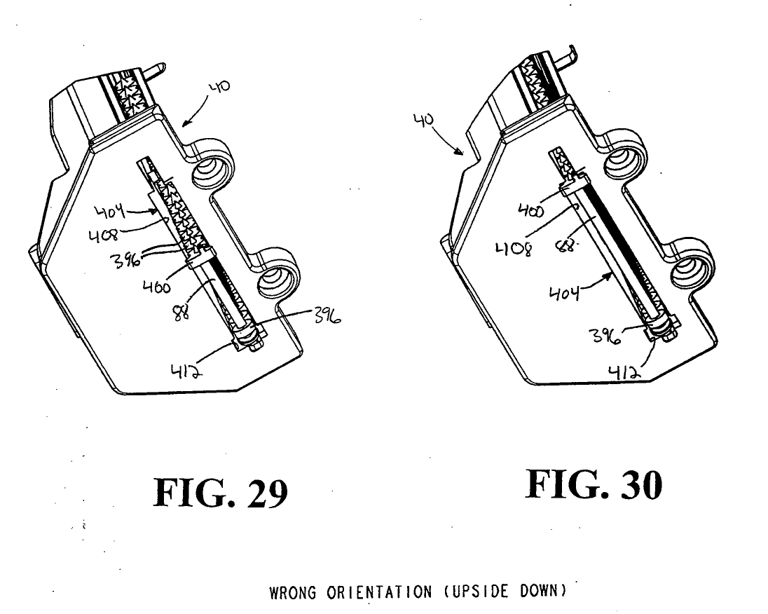

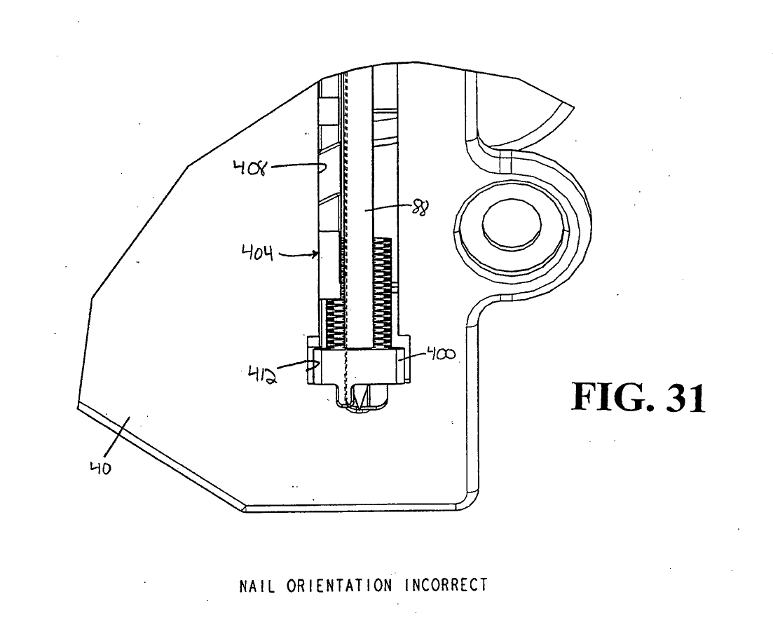

Referring to FIGS. 29-30, incorrect insertion of fasteners 88 having the collation strips 396, 400 is illustrated. The wide collation strip 400 engages the thin portion 408 of the insertion opening 404 when the fasteners 88 are inserted upside down. This engagement prevents the fasteners 88 from being inserted upside down in the magazine 40. FIG. 31 also illustrates incorrect insertion of the fasteners 88. Attempting to insert the fasteners 88 in a reversed orientation causes the wide collation strip 400 to engage the end of the magazine 40 and prevent the fasteners 88 from being inserted into the magazine 40.

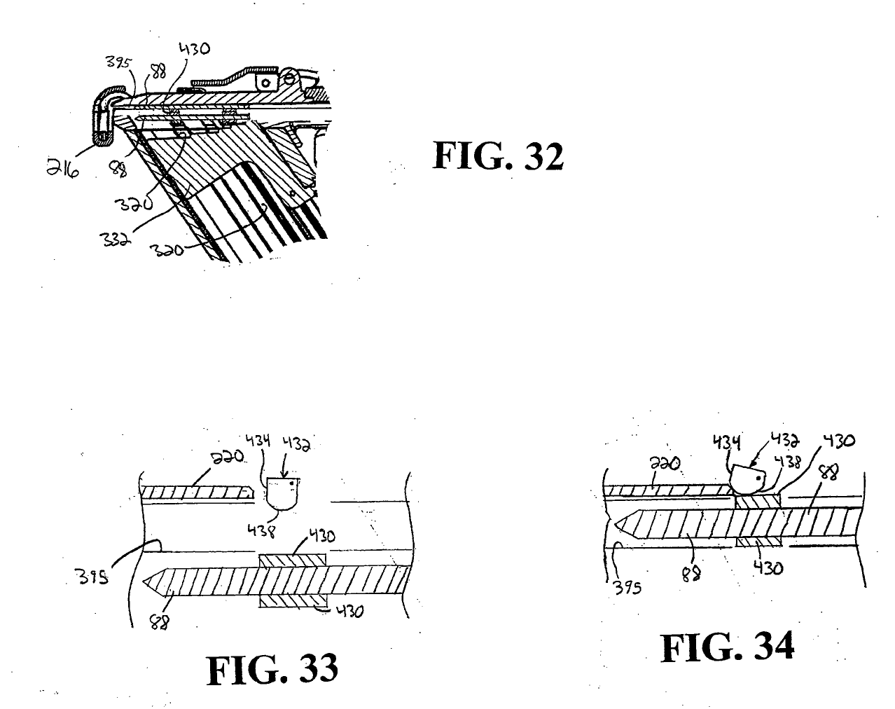

Referring to FIGS. 32-34, in the illustrated construction and in some aspects, collation material 430 can be positioned on the fasteners 88 in a manner that brings the collation material 430 into engagement with a nose-lockout switch 432 when the fasteners 88 are inserted into the magazine 40 in the correct orientation only. When firing the nailer 20, the driver pad 216 is depressed against a workpiece. If the fasteners 88 are inserted into the magazine 40 incorrectly, the collation material 430 will not engage the nose-lockout switch 432 and the nailer 20 will not be able to fire.

With particular reference to FIG. 33, the nose-lockout switch 432 is illustrated in a locked position, in which the nailer 20 can not fire. The nose-lockout switch 432 is pivotal and includes a flat engagement surface 434 and a curved engagement surface 438. In the locked position, the flat engagement surface 434 is aligned with the first lever 220 and the curved engagement surface 438 is positioned within the firing channel 395. Fasteners 88 are positioned in the firing channel 395 when they are in the loading position and the driver blade 152 is insertable into the firing channel 395 to engage the fastener 88 and drive it into a workpiece. When the driver pad 216 is depressed and the nose-lockout switch 432 is in the locked position, the first lever 220 engages the flat engagement surface 434 and is prevented from further movement by the nose-lock out switch 432. In the locked position, the nose-lockout switch 432 is not rotatable under force applied by the first lever 220 and, therefore, the driver pad 216 can not be depressed. The nose-lockout switch 432 can be in the locked position when the magazine 40 is out of fasteners 88 or when the fasteners 88 are incorrectly inserted into the magazine 40. Either way, the collation material 430 does not contact the nose-lockout switch 432.

Referring to FIG. 34, the nose-lockout switch 432 is illustrated in the unlocked position, in which the nailer 20 can fire fasteners 88 into a workpiece. The fastener 88 is correctly positioned in the magazine 40 and is in the firing channel 395. When the fastener 88 is correctly positioned in the firing channel 395, the collation material 430 engages the nose-lockout switch 432 and rotates the nose-lockout switch 432 to align the curved engagement surface 438 with the first lever 220. When the driver pad 216 is depressed and the nose-lockout switch 432 is in the unlocked position, the first lever 220 engages the curved engagement surface 438 and rotates the nose-lockout switch 432. Rotation of the nose-lockout switch 432 allows the first lever 220 to pass thereby, which allows the driver pad 216 to be depressed and the nailer 20 to be fired.

It should be understood that the nose-lockout switch can operate in a different manner and can be interconnected with other components of the nailer and still be within the spirit and scope of the present invention. For example, the nose-lockout switch can prevent movement of the second unwanted-firing prevention lever when in the locked position and the nose-lockout switch can slide between the locked and unlocked positions.

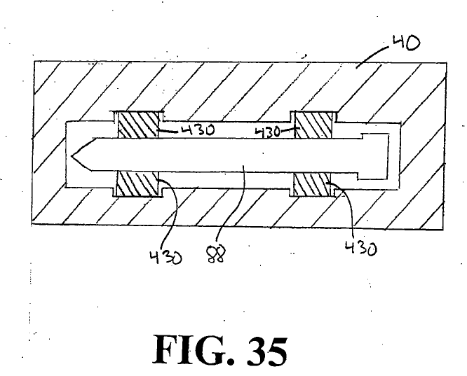

Referring to FIG. 35, in the illustrated construction and in some aspects, the collation material 430 is positioned on the fasteners 88 to engage interior surfaces of the magazine 40. Engagement between the collation material 430 and the interior surfaces of the magazine 40 provides support and guidance to the fasteners 88 within the magazine 40.

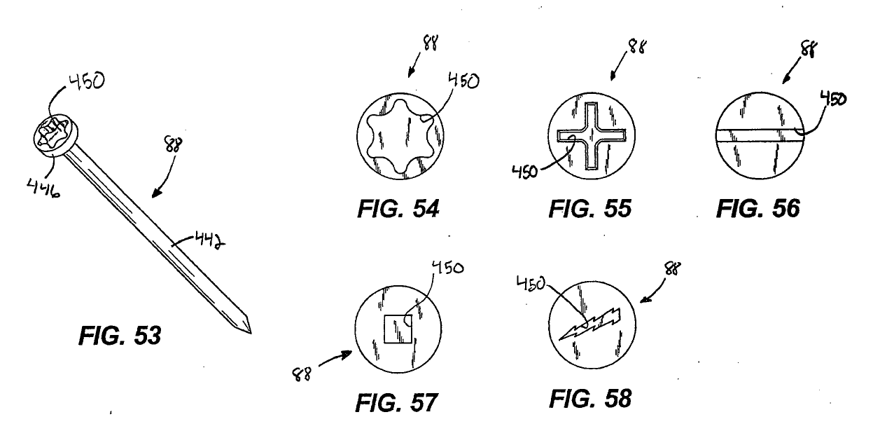

In the illustrated construction, the fasteners 88 are nails, however, the fasteners 88 can be any driveable fastener and still be within the spirit and scope of the present invention. Referring to FIGS. 53-58, the nails 88 include a shank 442, a head 446 and an indicia 450 defined in the head 446 of the nail 88. The indicia 450 has a variety of purposes. The indicia 450 provides a location where a tool (not shown) can engage the nail 88 for removal of the nail 88. The nail 88 is removed by engaging the tool with the nail 88 within the indicia 450 and turning the nail 88 with the tool until the nail 88 is removed from the workpiece. In some constructions, the nail 88 is turned counter-clockwise by the tool for removal of the nail 88. In other constructions, the nail 88 is turned clockwise by the tool for removal of the nail 88.

Also, the indicia 450 indicates the manufacturer of the nail 88. Inspectors that inspect job sites must be able to determine the manufacturer of nails 88 used in structural applications by referencing a unique marking on the nails 88. The indicia 450 can assume a variety of patterns and shapes corresponding to a variety of manufacturers of nails 88.

Referring to FIGS. 53-54, a nail 88 is illustrated and the indicia 450 has a Torx T10 configuration. A tool having a complementary Torx T10 configuration is engageable with the nail 88 within the indicia 450 and is rotatable to remove the nail 88.

It should be understood that the nail 88 can define an indicia 450 having a variety of configurations, such as, for example a Phillips-type configuration (see FIG. 55), a flathead-type configuration (see FIG. 56), a square configuration (see FIG. 57), a lighting bolt configuration (see FIG. 58), or any other configuration that would enable removal of the nail 88 by engaging the nail 88 with a tool within the indicia 450 and turning the tool. Likewise, tools can be designed to include a complementary configuration to the indicia configurations listed above and to any other indicia configuration that would enable removal of the nail 88.

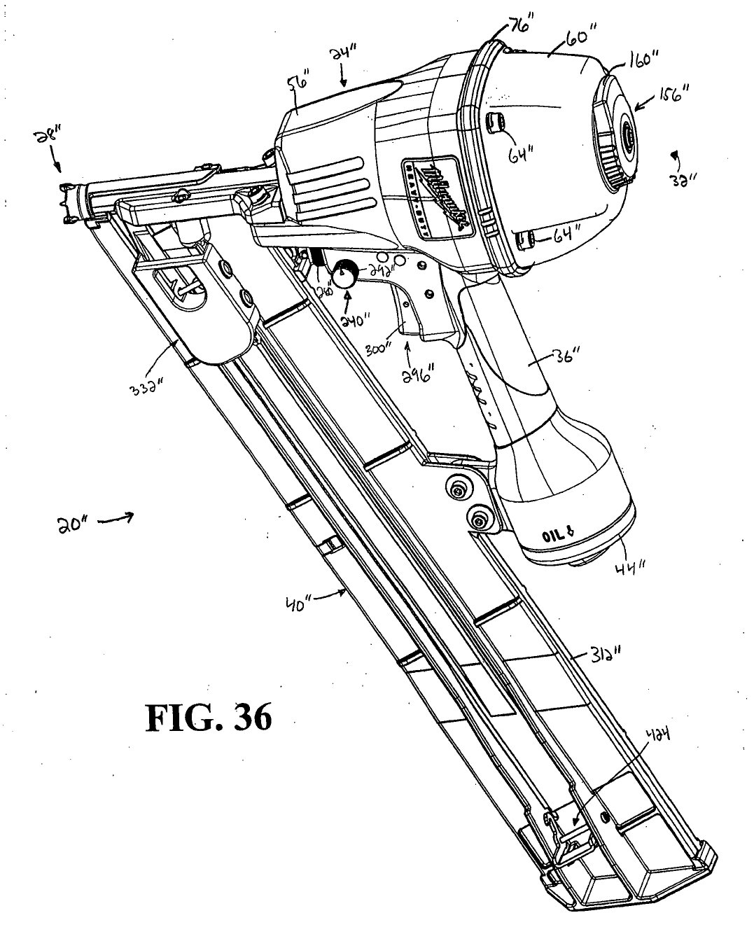

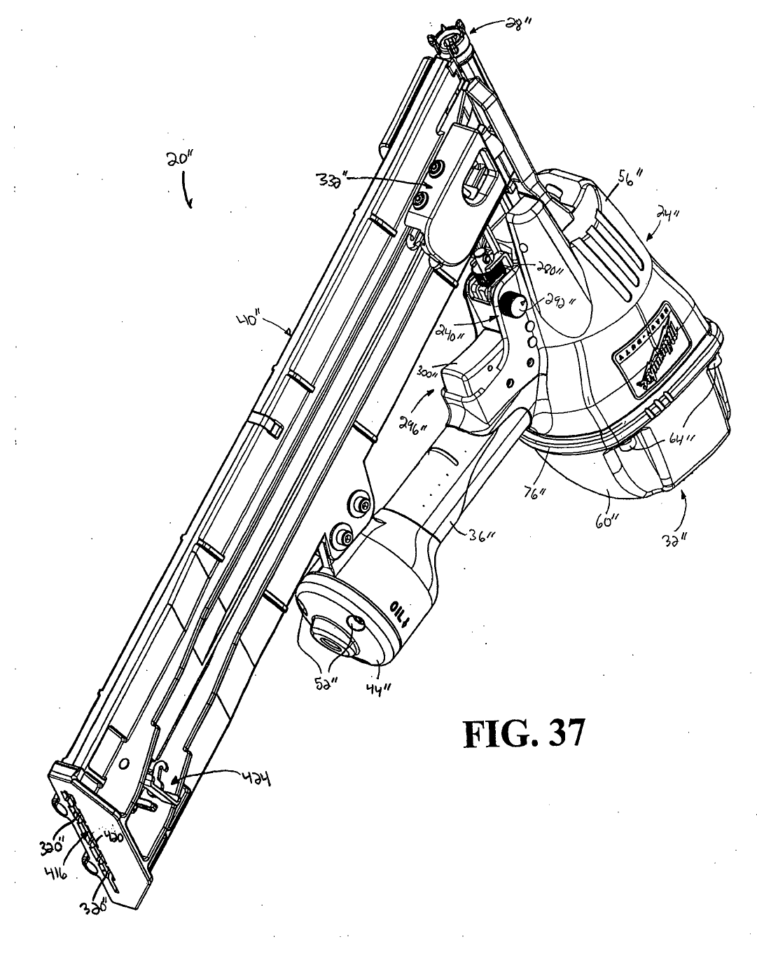

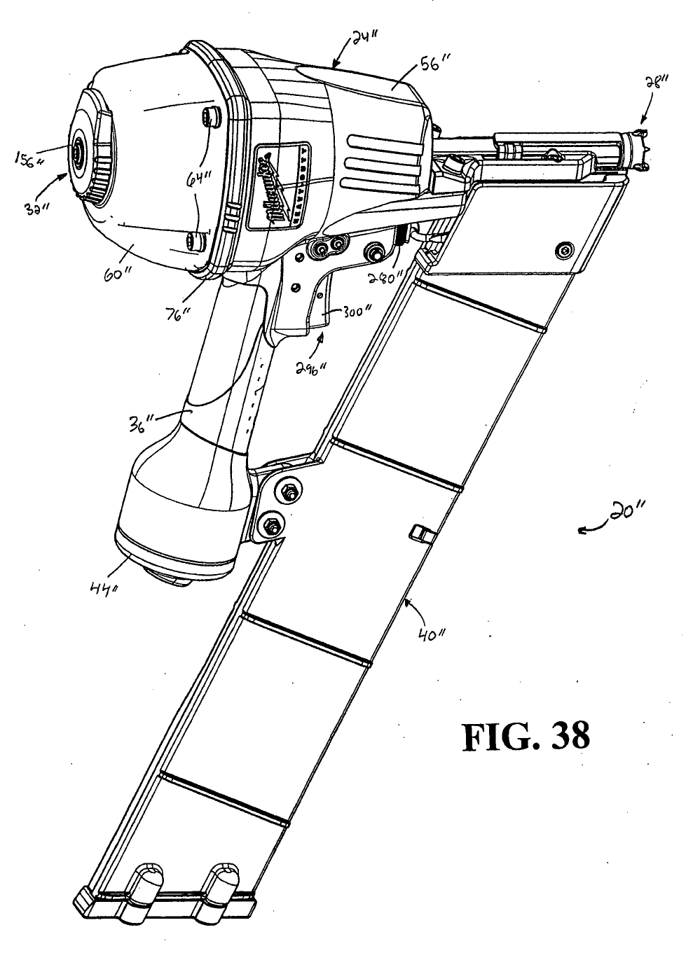

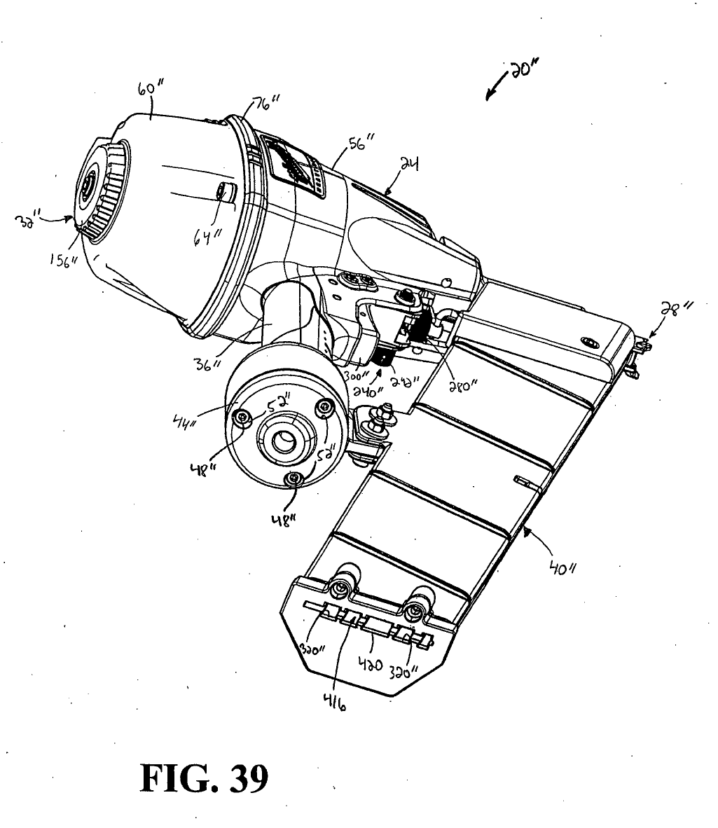

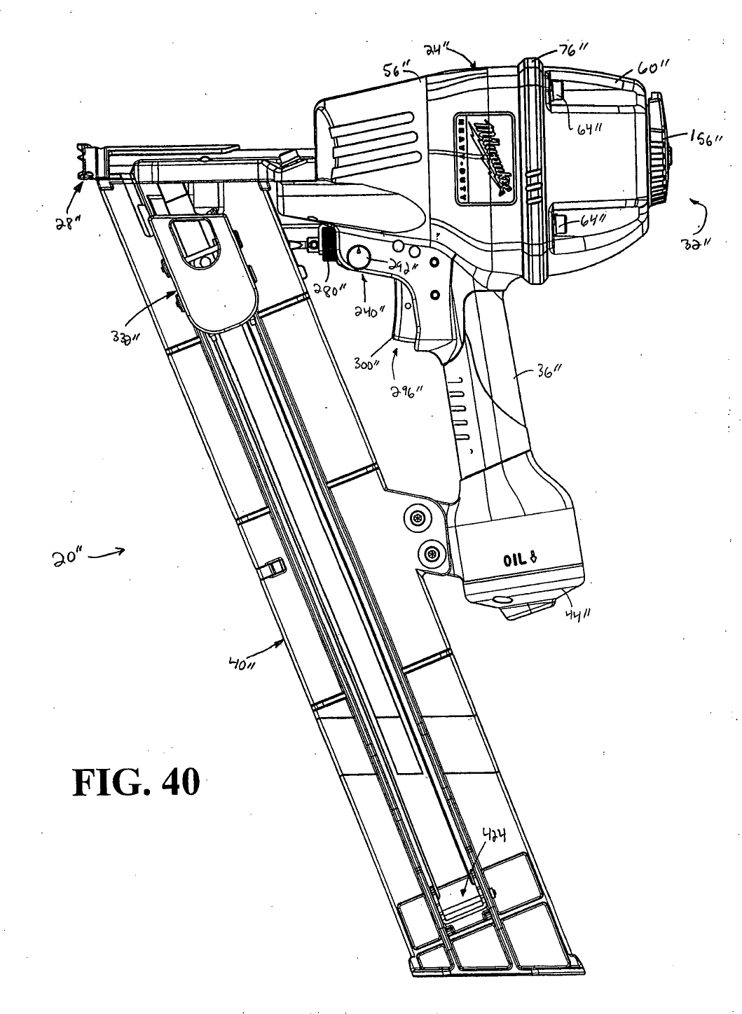

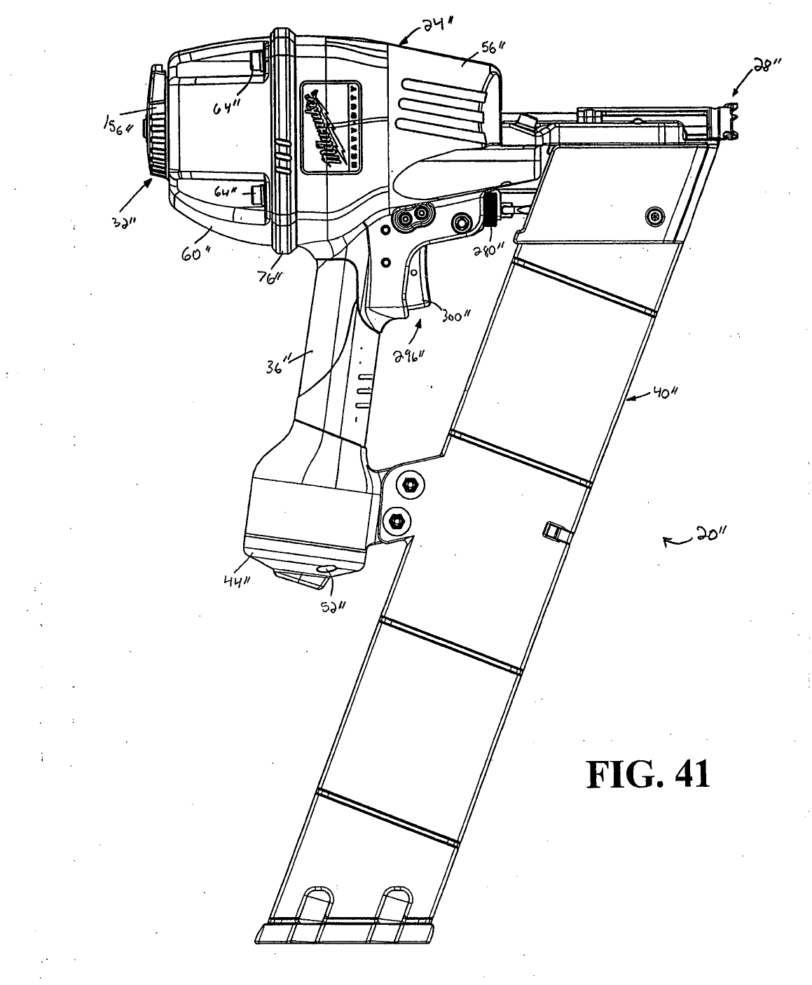

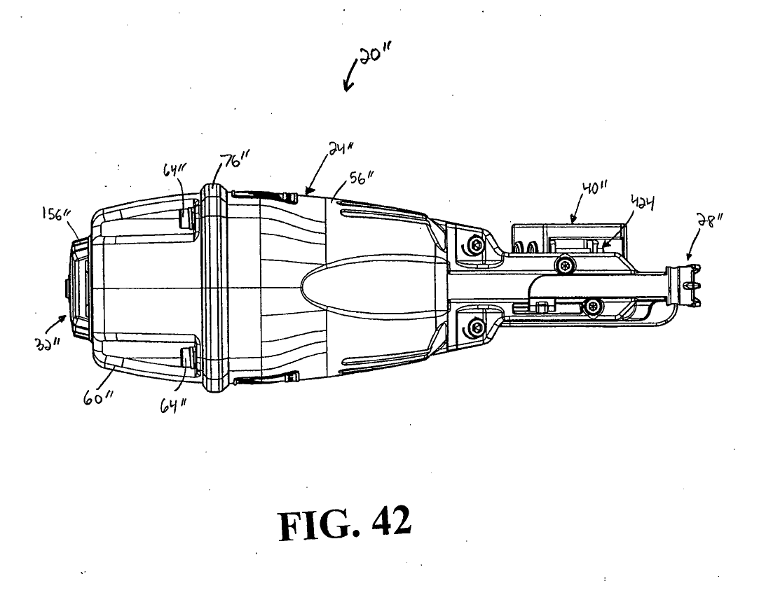

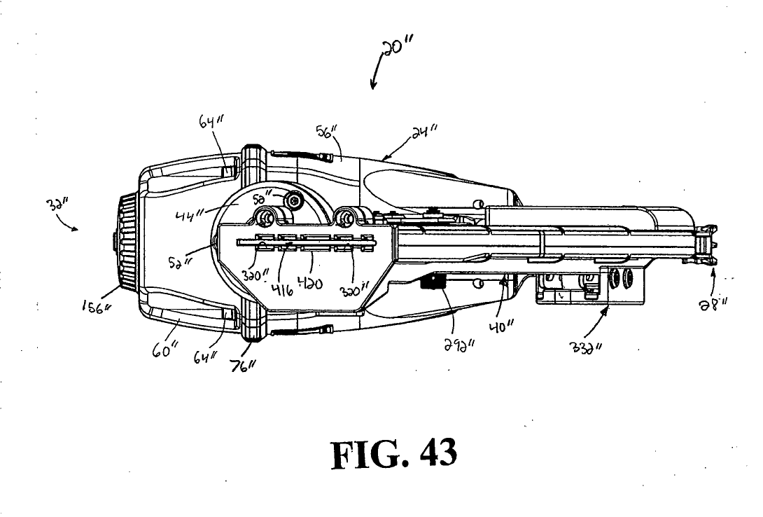

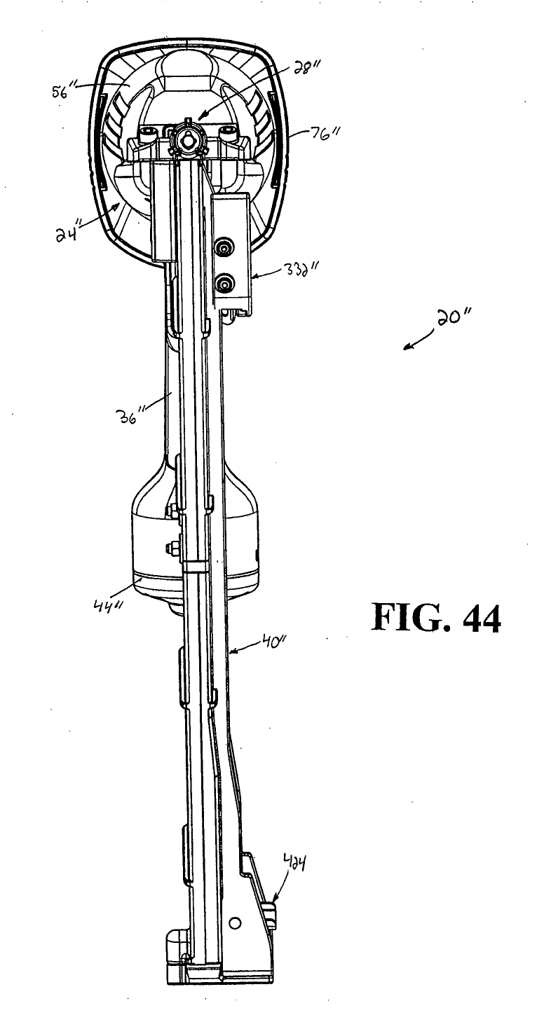

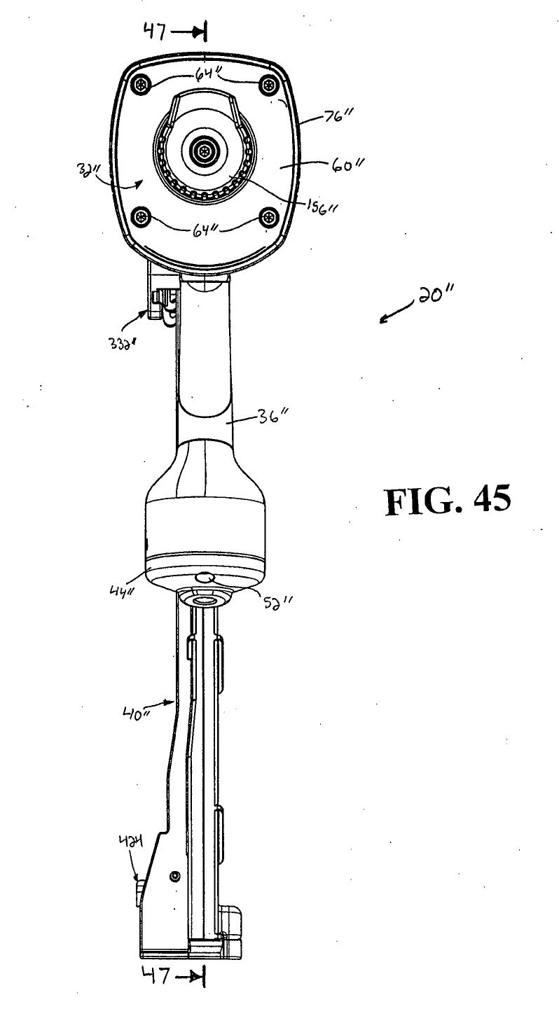

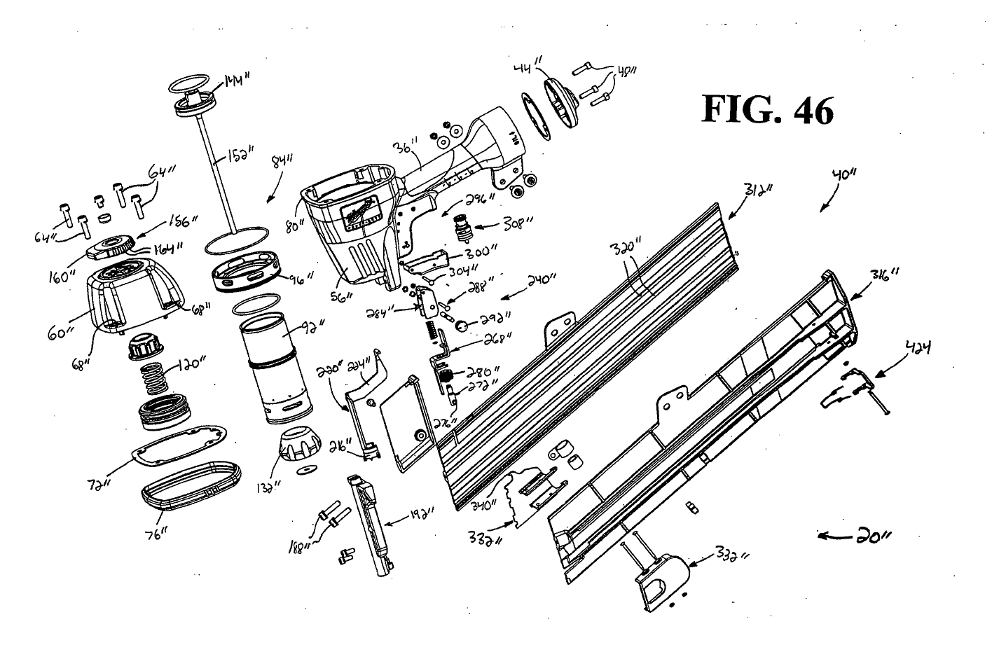

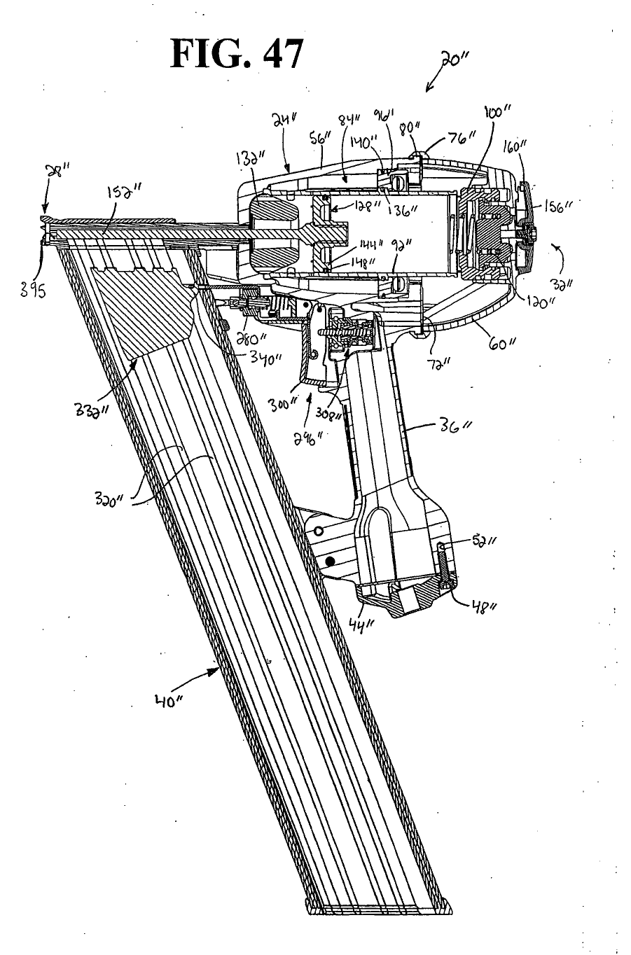

Referring to FIGS. 36-47, a second construction of the nailer 20 is illustrated. Common elements are identified by the same reference numbers “″”.

It should be understood that the nailer 20″ illustrated in FIGS. 36-47 can have similar operation to the nailer 20 illustrated in FIGS. 1-15 and include any of the structure and alternatives of the nailer 20 illustrated in FIGS. 1-15. Similarly, the nailer 20″ illustrated in FIGS. 36-47 can utilize the magazine 40′ illustrated in FIGS. 16-22 and the collation material illustrated in FIGS. 23-26. Accordingly, reference is made to the above discussion regarding the structure, operation, and alternatives of the nailer 20. Likewise, the nailer 20 can have similar structure, operation and alternatives of the nailer 20″ illustrated in FIGS. 36-47.

The nailer 20″ is a steel, framing, sheathing nailer for fastening steel to concrete, heavy steel to heavy steel, sheathing to steel, etc. The nailer 20″ includes a magazine 40″ connected to the handle 36″ and the forward end 28″ of the body 24″. The magazine 40″ includes a support portion 312″ defining a fastener channel 416 therein for receiving and supporting fasteners 88″. An insertion opening 420 is defined in a rearward end of magazine 40″ for inserting fasteners 88″ into the magazine 40″. A pusher 332″ is engageable with the fasteners 88″ to bias the fasteners 88″ toward the loading position in the forward end 28″ of body 24″.

To load fasteners 88″ into the magazine 40″, the pusher 332″ is pulled rearward until it is locked in place with a locking member 424. While moving rearward, the pusher 332″ engages a ramp (not shown) within the magazine 40″ to move the pusher 332″ out of the fastener channel 416 defined in the magazine 40″. Fasteners 88″ are inserted through the insertion opening 420 and into the fastener channel 416. The nailer 20″ is then rotated upside-down to allow gravity to move the fasteners 88″ forward toward the forward end 28″ of the body 24″. The pusher 332″ is released from the locking member 424 and is spring biased into engagement with the last fastener 88″ to bias the fasteners 88″ toward the loading position.

Although particular constructions of the present invention have been shown and described, other alternative constructions will be apparent to those skilled in the art and are within the intended scope of the present invention.

We claim:

1. A power tool comprising:
a housing including a wall having an interior surface and an exterior surface, the interior surface defining a cavity with an opening;
a cap formed separately from the housing and connectable to the housing, the cap at least partially covering the opening when connected to the housing, wherein a seam is provided between the housing and the cap when the cap is connected to the housing; and
a bumper at least partially extending along the exterior surface of the housing and at least partially covering the seam.

2. The power tool of claim 1, wherein the power tool is a nailer.

3. The power tool of claim 1, wherein the bumper is removably connected to at least one of the housing and the cap.

4. The power tool of claim 1, wherein the bumper is unitary with at least one of the housing and the cap.

5. The power tool of claim 1, wherein one of the housing and the cap includes one of a projection or a recess and the bumper includes the other of the projection or the recess, and wherein the projection is insertable into the recess to removably connect the bumper to the one of the housing and the cap.

6. The power tool of claim 1, wherein the housing includes a projection extending from the exterior surface of the housing and the bumper includes a recess, the projection being insertable into the recess to removably connect the bumper to the housing.

7. The power tool of claim 1, wherein the bumper is made of a resilient material and the bumper is elastically connected to one of the housing and the cap in a position to at least partially cover the seam.

8. The power tool of claim 7, wherein the bumper is made of rubber.

9. The power tool of claim 7, wherein the bumper is made of plastic.

10. The power tool of claim 1, wherein the bumper includes a projection and one of the housing and the cap include a recess, the projection being positionable in the recess to removably connect the bumper to the one of the housing and the cap.

11. The power tool of claim 10, wherein the housing includes the recess.

12. The power tool of claim 1, wherein the bumper includes a projection, the projection being positionable in the seam and compressed between the housing and the cap when the housing and cap are connected.

13. The power tool of claim 1, wherein the bumper completely covers the seam.

14. A nailer comprising:
a housing including a wall having an interior surface and an exterior surface, the interior surface defining a cavity with an opening, the exterior surface including a projection extending therefrom adjacent the opening;
a cap formed separately from the housing and connectable to the housing, the cap at least partially covering the opening when connected to the housing, a seam being provided between the housing and the cap when the cap is connected to the housing; and
a resilient bumper including a recess and being removably connected to the housing by positioning the projection of the housing in the recess of the bumper, wherein the bumper at least partially covers the seam when connected to the housing.

15. The nailer of claim 14, wherein the bumper completely covers the seam.

16. A nailer comprising:
a housing; and
a resilient bumper removably connected to the housing.

17. The nailer of claim 16, wherein the housing includes a projection and the resilient bumper includes a recess and the bumper is removably connected to the housing by positioning the projection in the recess.

18. The nailer of claim 16, wherein the resilient bumper is a first resilient bumper, the nailer further comprising a second resilient bumper including a second recess, the second resilient bumper being removably connected to the housing by positioning the projection in the second recess after the first resilient bumper is removed from the housing.
